(19) United States
(12) Patent Application Publication
(10) Pub. No.: US 2007/0074109 A1
(43) Pub. Date: Mar. 29, 2007

(54) Document production system, document production method, program, and storage medium

(75) Inventors: Atsushi Nagahara, Chino (JP); Hitoshi Yamakado, Hino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 11/512,530

(22) Filed: Aug. 30, 2006

(30) Foreign Application Priority Data
May 30, 2006 (JP) 2006-149080
Sep. 28, 2005 (JP) 2005-281513
Nov. 22, 2005 (JP) 2005-336649

(51) Int. Cl. G06F 17/00

(52) U.S. Cl. 715/517; 715/526

(57) ABSTRACT

A document production system includes: a document acquisition unit that acquires a document including data including at least one object placed in a layout area and layout information identifying the placement of the at least one object in the layout area; an attribute information generation unit that generates attribute information describing the attributes of the document based on at least either one of the object(s) and layout information included in the document acquired by the document acquisition unit; and a layout processing unit that processes at least either one of the layout information or an object among the at least one object based on the attribute information generated by the attribute information generation unit.

The entire disclosure of Japanese Patent Applications No. 2005-281513, filed on Sep. 28, 2005, No. 2005-336649 filed on Nov. 22, 2005, and No. 2006-149080 filed on May 30, 2006, are expressly incorporated by reference herein.

### BACKGROUND OF THE INVENTION

1. Field of the Invention

The present invention relates to a technology for producing documents including at least one object (digital content).

2. Description of the Related Art

Content distribution systems providing users with news and other objects (digital content) are well-known. Generally speaking, a content distribution system first reads a plurality of objects from a content database. Next, the content distribution system edits the objects that has read and generates a document that includes the objects. In addition, the content distribution system provides the document to the user. In the process of editing the objects, the objects are edited with a view to improve their visibility. In general, a plurality of placeholder frames used for the placement of images and text, etc. included in the objects are placed in a layout area. The objects are placed in accordance with the placeholder frames.

Such an editing process is fraught with various problems. For example, one problem is caused by the unnecessary blank spaces generated in placeholder frames when the font size of the text is too small for placeholder frames. Another problem is the inability of placeholder frames to hold text when the font size of the text is too large for the placeholder frames. In addition, yet another problem is that text on different pages ends up having different font sizes and line spacing when text overflows from a placeholder frame on one page into a placeholder frame on another page. Additionally, a problem that arises when objects corresponding to a certain placeholder frame are modified is that text in the modified objects and other objects ends up having different font sizes and line spacing. Still another problem is that such phenomena cause degradation in the visibility or esthetics of objects intended for output.

Technologies addressing such problems include, For example, technologies described in JP-A-S63-221457 and JP-A-H1-185761. JP-A-S63-221457 discloses a technology, in which the format of a document is modified such that document data is kept on a specified page. JP-A-H1-185761 discloses a technology, in which the allocation of document data is automatically corrected based on the structural attributes of the document data.

Because the technologies of JP-A-S63-221457 and JP-A-H1-185761 were designed for typesetting, production of documents not intended for typesetting has been associated with some problems. For example, when objects are placed in such a manner that they extend over a plurality of pages, it is difficult to produce documents (output objects) of high design characteristics while maintaining balance throughout the entire layout area.

### SUMMARY

By contrast, the invention provides a technology for producing documents with high design characteristics while maintaining balance throughout the entire layout area.

According to an aspect of the invention, a document production system includes: a document acquisition unit that acquires a document including data including at least one object placed in a layout area and layout information identifying the placement of the at least one object in the layout area; an attribute information generation unit that generates attribute information describing the attributes of the document based on at least either one of the object(s) and layout information included in the document acquired by the document acquisition unit; and a layout processing unit that processes at least either one of the layout information or an object among the at least one object based on the attribute information generated by the attribute information generation unit.

It is preferable that the layout information includes importance information describing the importance of each object among the at least one object, the attribute information generation unit generates attribute information including importance distribution information describing the distribution of importance in the layout area, and the layout processing unit processes at least either one of the layout information or an object among the at least one object based on the importance distribution information.

It is preferable that the document production system further includes a segment importance information generation unit that generates, for each segmental area obtained by segmenting the layout area into a plurality of areas, segment importance information describing the importance of the segmental area based on importance information concerning objects corresponding to the segmental area or importance information concerning at least one object corresponding to another segmental area disposed in a specified positional relationship relative to the segmental area, wherein the attribute information generation unit generates importance distribution information based on the segment importance information generated by the segment importance information generation unit.

It is preferable that the document further comprises information describing an output unit of the document, and the layout area is different from the output units.

It is preferable that the layout information includes category information describing the categories of each one of the plurality of objects, and the attribute information generation unit generates attribute information based on the category information.

It is preferable that the layout information includes size information describing the size of each one of the plurality of objects, and the attribute information generation unit generates attribute information based on the size information.

It is preferable that the attribute information generation unit generates attribute information including shape information describing the shape of each one of the at least one object.

It is preferable that the attribute information generation unit generates attribute information including overlapping information describing the overlapping of objects.

It is preferable that the attribute information generation unit generates attribute information including blank space information describing blank space, i.e. an area other than the areas occupied by the at least one object in the layout area.

It is preferable that the attribute information generation unit generates attribute information including importance distribution information describing the distribution of color within the layout area.

It is preferable that the document production system further includes: a content storage unit that stores a plurality of objects; a layout storage unit that stores a plurality of layout information items; a selection unit that selects a layout information item from the plurality of layout information items stored in the layout storage unit and at least one of the plurality of objects stored in the content storage unit; and an initial layout unit that places the at least one object selected by the selection unit in the layout area in accordance with the layout information selected by the selection unit and generating a document, wherein the document acquisition unit acquires the document generated by the initial layout unit.

It is preferable that the document production system further includes a design expertise information storage unit that stores design expertise information including rules for processing at least either one of the layout information or an object among the at least one object, wherein the layout processing unit processes at least either one of the layout information or an object among the at least one object based on the design expertise information stored in the design expertise information storage unit.

According to another aspect of the invention, a document production method, includes: acquiring a document including data including at least one object placed in a layout area and layout information identifying the placement of the at least one object in the layout area; generating attribute information for the acquired document based on at least either one of the object(s) and layout information included in the acquired document; and processing at least either one of the layout information or an object among the at least one object based on the attribute information.

According to still another aspect of the invention, a program causes a computer to execute: acquiring a document including data including at least one object placed in a layout area and layout information identifying the placement of the at least one object in the layout area; generating attribute information for the acquired document based on at least either one of the object(s) and layout information included in the acquired document; and processing at least either one of the layout information or an object among the at least one object based on the attribute information.

According to still another aspect of the invention, a storage medium for storing a program that causes a computer to execute: acquiring a document including data including at least one object placed in a layout area and layout information identifying the placement of the at least one object in the layout area; generating attribute information for the acquired document based on at least either one of the object(s) and layout information included in the acquired document; and processing at least either one of the layout information or an object among the at least one object based on the attribute information.

### BRIEF DESCRIPTION OF THE DRAWINGS

The invention will be described with reference to the accompanying drawings, wherein like numbers reference like elements.

FIG. 1 shows a functional configuration of a document production apparatus of a first embodiment.

FIG. 2 is a diagram showing the hardware configuration of the document production apparatus 100.

FIG. 3 illustrates object creation processing according to the first embodiment.

FIG. 4 is a diagram showing an exemplary layout template.

FIG. 5 is a diagram showing an example of objects.

FIG. 6 is a diagram showing an example of objects after initial layout.

FIG. 7 is a flowchart showing details of document attribute information generation processing.

FIG. 8 is a diagram showing details of placement information generation processing.

FIG. 9 is a diagram illustrating objects after grouping.

FIG. 10 provides a visual representation of document attribute information.

FIG. 11 is a flowchart showing details of overlapping information generation processing.

FIG. 12 is a flowchart showing details of blank space information generation processing.

FIG. 13 is a flowchart showing details of importance distribution information generation processing.

FIG. 14 is a flowchart showing details of color distribution information generation processing.

FIG. 15 is a flowchart showing details of layout adjustment processing.

FIG. 16 is a flowchart showing details of unoverlapping processing.

FIG. 17 is a flowchart showing details of unoverlapping processing.

FIG. 18 is a diagram showing an exemplary document obtained after initial layout.

FIG. 19 provides a visual representation of document attribute information.

FIG. 20 is a diagram showing an example of unoverlapping processing.

FIG. 21 is a diagram showing an exemplary document obtained after layout adjustment processing.

FIG. 22 is a diagram showing an example of design expertise information.

FIG. 23 is a diagram showing an exemplary document obtained after design processing.

FIG. 24 is a diagram showing a modified example of design expertise information.

FIG. 25 is a diagram showing a modified example of the layout area.

FIG. 26 shows a functional configuration of a document production apparatus of a second embodiment.

FIG. 27 schematically illustrates the data structure of a document.

FIG. 28 provides a visual representation of importance distribution information.

FIG. 29 is a flowchart showing details of importance distribution information generation processing.

FIG. 30 illustrates an example of a document segmented into segmental areas.

FIG. 31 is a diagram showing calculated importance.

FIG. 32 is a diagram showing a modified example of peripheral segmental areas.

FIG. 33 is a diagram illustrating coefficients α.

FIG. 34 provides a visual representation of importance distribution information.

FIG. 35 is a diagram showing an example of design expertise information.

FIG. 36 is a flowchart showing details of design processing.

FIG. 37 is a flowchart showing blank space generation processing corresponding to Rule 1.

FIG. 38 provides a visual representation of importance distribution information generated in a second embodiment.

FIG. 39 shows a document obtained after design processing in the second embodiment.

### DESCRIPTION OF EXEMPLARY EMBODIMENTS

### First Embodiment

Configuration

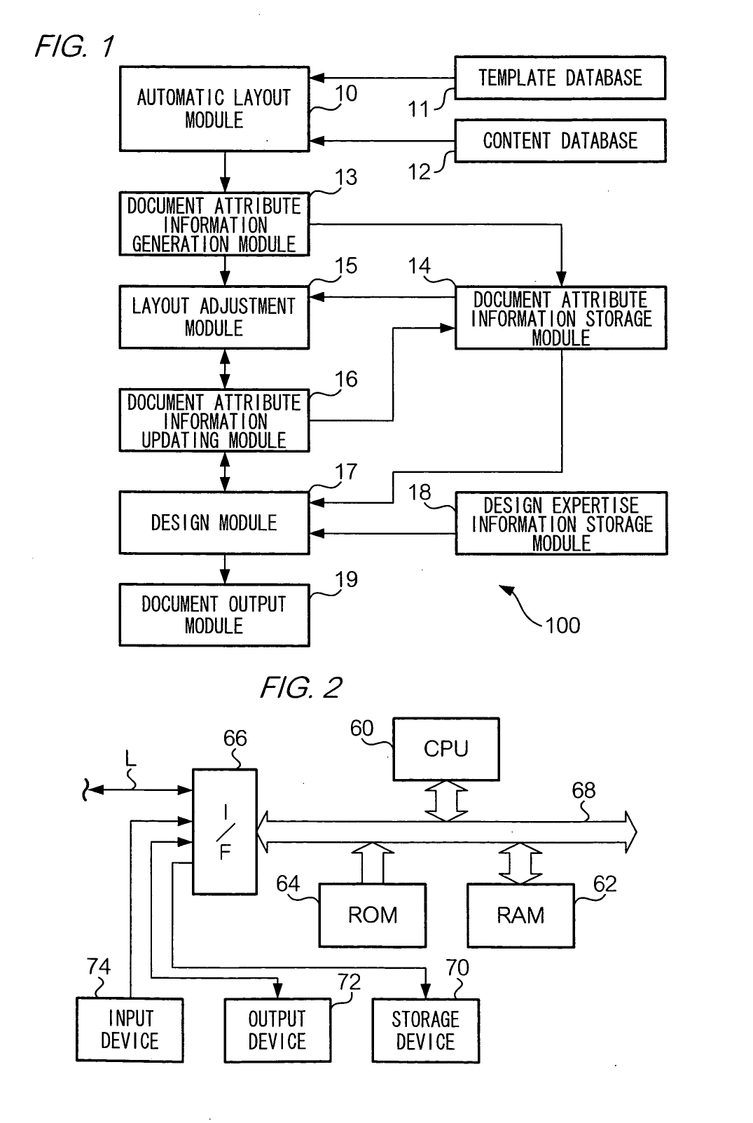

FIG. 1 is block diagram showing a functional configuration of a document production apparatus 100 of a first embodiment of the invention. An automatic layout module 10 automatically generates an initial layout for selected objects based on a layout template selected in accordance with user instructions. A content database 12 is used as a database for storing various objects. A template database 11 is used as a database for storing various layout templates. A document attribute information generation module 13 generates document attribute information from the document (digital content for output) produced by the initial layout. Here, the term “document” refers to digital data including at least one object and at least one layout information item, or images outputted based on such digital data. Information describing the placement of objects in a layout area is called “layout information”. Digital data items describing text (character strings) or images are called “objects”. The areas, in which the objects are placed, i.e. the units, in which layout adjustments explained below are performed, are called “layout areas”. A document attribute information storage module 14 stores the generated document attribute information. A layout adjustment module 15 adjusts (processes) the layout of the laid-out objects based on the document attribute information. A document attribute information updating module 16 updates the document attribute information based on objects with adjusted layout content. In addition, the document attribute information updating module 16 updates the document attribute information based on documents obtained by performing design processing in a design module 17, which will be described below.

The automatic layout module 10 acquires or obtains a layout template from the template database 11 in accordance with user instructions. In addition, the automatic layout module 10 acquires at least one object from the content database 12 in accordance with user instructions. Additionally, the automatic layout module 10 generates an initial layout for the acquired object(s) based on the layout information included in the acquired layout template.

The layout template includes layout information. The layout information includes at least information specifying the placement of objects within the layout area. Moreover, the layout information may include object attribute information describing the attributes of the placed objects. “Object attribute information” means information describing the attributes of individual objects. By contrast, “document attribute information” means information describing the attributes of an entire document including a plurality of objects. “Document attribute information” is generated, For example, based on object attribute information concerning objects included in a document. The object attribute information includes, For example, (1) category information describing the categories of the objects (For example, title, text, main image, or subimage, etc.), (2) placement information describing the placement of the objects (For example, information concerning placement within the printing paper area, specifically, coordinate values in a two-dimensional coordinate system), (3) importance information describing the importance of each individual object corresponding to its placement, (4) font information regarding text objects, such as font type, font size, font color, character spacing, or line pitch, etc., and (5) image information regarding image objects, such as the number, quality, size, or proportions of images, etc. The layout information is presented, For example, in HTML (HyperText Markup Language) or XML (Extensible Markup Language). It should be noted that the term “importance”, as used here, refers to information that is in a one-to-one correspondence with a plurality of objects, i.e. information describing the importance of each individual object. By contrast, “importance distribution information”, to be described later, refers to information describing how the importance of objects is distributed within the layout area. Thus, “importance” and “importance distribution information” refer to different concepts. Moreover, the automatic layout processing methods and template configurations are not limited to the ones explained above. Other automatic layout processing methods and layout templates of other configurations may be used. Moreover, the layout information may not include all the five object attribute information items mentioned above and may include other information items beyond the five object attribute information items mentioned above.

The template database 11 includes at least one layout template. Each layout template is produced for one of various intended uses such as, For example, a “catalog” or a “poster”.

The content database 12 is a database including at least either one of a plurality of text data items and a plurality of image data items. The text data items include, For example, text (character strings) associated with various intended uses, such as titles, text, catch phrases, etc. The image data includes various kinds of images, such as background images, images of people, images of animals, or images of products, etc.

The document attribute information generation module 13 generates document attribute information. The document attribute information is information describing the attributes of an entire document including at least one object laid out in the layout area. In the present embodiment, a single page, a plurality of pages, or a section may be used as the layout area. The term “page” means an output unit in an output device. The document includes information describing output units, For example, information describing partitioning into pages. The term “section” means a page-independent layout area. That is, some sections may extend over a plurality of pages. Alternatively, some pages may include a plurality of sections. Thus, in this embodiment, the term “layout area”, i.e. the unit of layout adjustment processing, and the term “page”, i.e. the output unit, may refer to the same or different things. In particular, when the layout area and the output unit are different, decisions are made based on rules relating to the entire document extending over a plurality of pages, which permits production of documents of high design characteristics while maintaining balance throughout the entire layout area. The document attribute information generation module 13 generates document attribute information based on at least one object laid out in the layout area or object attribute information concerning the object(s). The document attribute information includes, For example, placement information describing the placement of objects, overlapping information describing the overlapping of at least two objects, blank space information describing blank space, i.e. areas other than the areas occupied by the objects within the layout area, and importance information describing the distribution of object importance. Thus, in this embodiment, document attribute information is generated using the layout area as a unit. Moreover, as will be described later, design processing is carried out based on the generated document attribute information. As a result, the produced document has high design characteristics while maintaining balance throughout the entire layout area. Modifying the layout area modifies the area subject to design processing, in other words, the area subject to balance considerations.

The document attribute information storage module 14 stores the document attribute information generated by the document attribute information generation module 13 or the document attribute information updated by the document attribute information updating module 16.

The layout adjustment module 15 adjusts the layout content of the initially laid-out objects based on the document attribute information stored in the document attribute information storage module 14, that is, updates the layout information or processes the objects. The layout adjustment module 15 performs e.g. object unoverlapping, grid adjustment, image size adjustment, font size adjustment, or color adjustment.

The document attribute information updating module 16 regenerates document attribute information based on updated layout information, For example, placement information, size information, color information, etc. Moreover, the document attribute information updating module 16 updates the document attribute information stored in the document attribute information storage module 14 based on the layout information used for design in the design module 17, e.g. placement information, size information, color information, etc.

The design module 17 subjects documents to design processing based on design expertise information stored in a design expertise information storage module 18. The design expertise information is obtained by describing the layout design expertise of designers etc. in the form of rules and saving them in computerized form. That is, the design module 17 performs processing that improves the design characteristics of the document based on the design expertise of designers.

The design expertise information storage module 18 stores design expertise information obtained by describing the expertise of designers in the layout design of catalogs, posters, etc. in the form of rules and saving it in computerized form.

The document output module 19 outputs the document produced via design in the design module 17 from an output device. For example, if the output device is a display, the output device displays images based on the document. Otherwise, if the output device is an image-forming device such as a printer, images based on the document are formed on print media.

FIG. 2 shows the hardware configuration of the document production apparatus, 100. The CPU (Central Processing Unit) 60, is a central processing unit carrying out various types of control and arithmetic operations. RAM (Random Access Memory) 62 is a main storage device. The ROM (Read Only Memory) 64, is a read-only storage device. The internal/external bus 68 connects the above-mentioned elements. The internal/external bus 68 is e.g. a PCI (Peripheral Component Interconnect) bus or an ISA (Industrial Standard Architecture) bus. The I/F 66 is an interface used for performing the input/output of data and control signals to and from external devices. The external storage unit 70 is a storage device such as a HDD (Hard Disk Drive). The output device 72 is a display such as a CRT (Cathode Ray Tube) or an LCD (Liquid Crystal Display), or an image forming device such as a printer. The input device 74 is an operator control panel, a mouse, a keyboard, and the like. Moreover, the document production apparatus 100 can send and receive data to/from other devices via a network L (not shown in the Fig.) and the I/F 66.

When the power supply (not shown in the Fig.) is turned on, the CPU 60 reads and executes system program such as a BIOS (Basic Input/Output System), which is stored in the ROM 64. Upon execution of the system program the CPU 60 reads and executes an object creation program stored in the external storage unit 70. In view of executing the object creation program, the document production apparatus 100 has the functional configuration illustrated in FIG. 1.

1.2. Operation

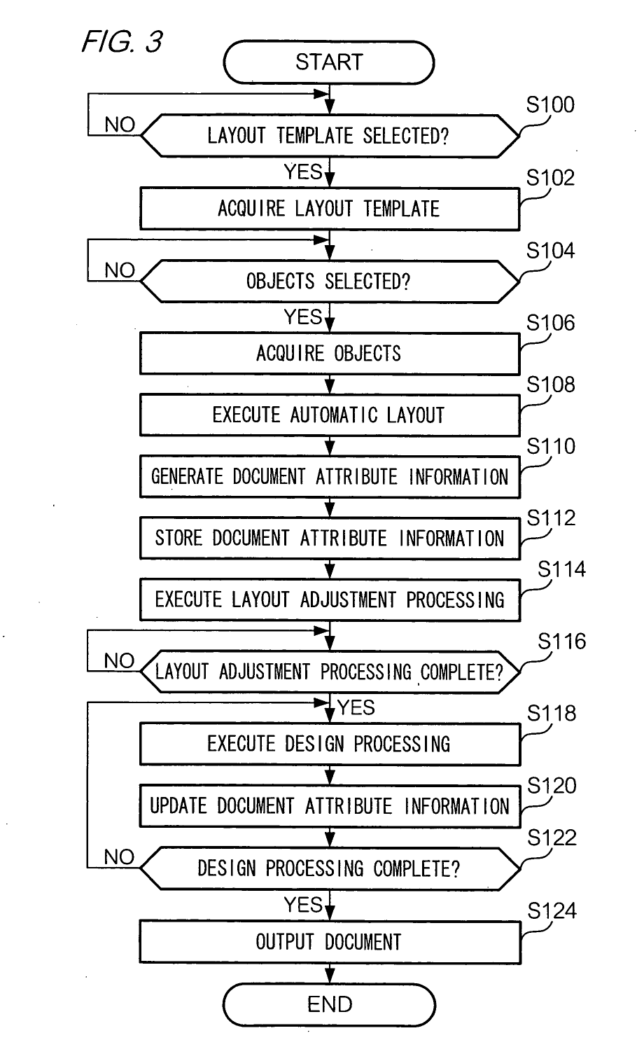

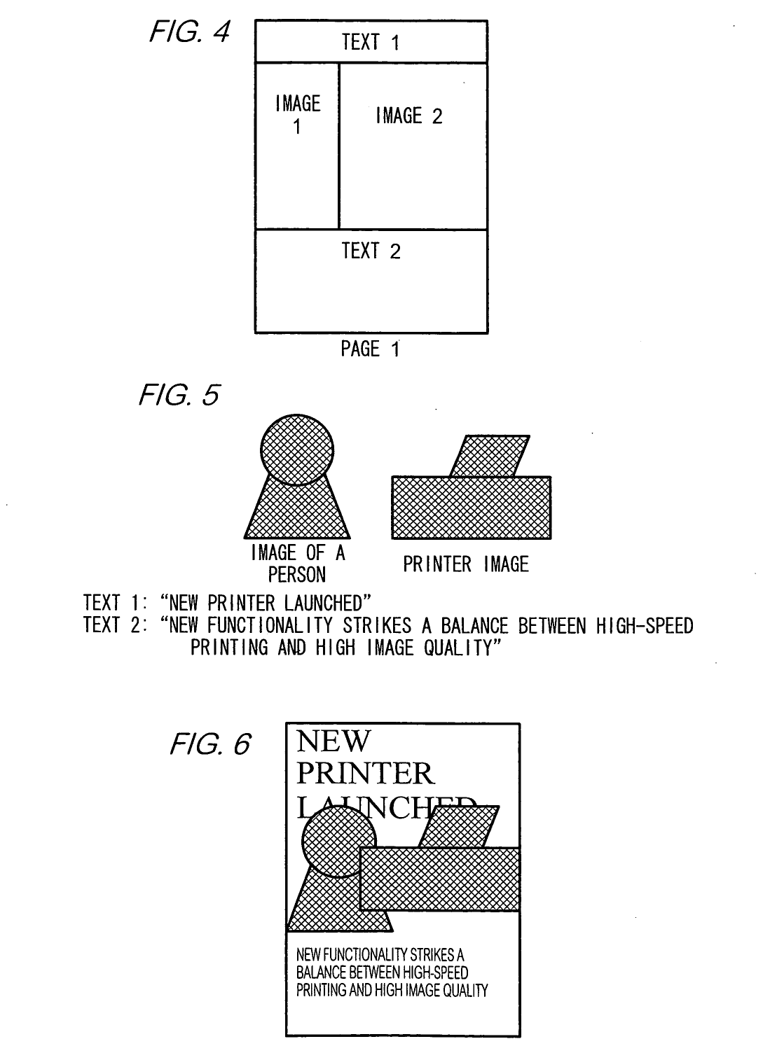

FIG. 3 is a flowchart showing object creation processing in the first embodiment. FIG. 4 illustrates an exemplary layout template. FIG. 5 illustrates exemplary objects. FIG. 6 illustrates an example of an initial object layout based on a layout template.

After the initial operation is over, in step S100, the CPU 60 of the document production apparatus 100 determines whether the user has selected a layout template based on selection instructions acquired via the input device 74. If it is determined that the user has selected a layout template (“Yes” in Step S100), the CPU 60 transfers processing to step S102. If it is determined that the user has not selected a layout template (“No” in Step S100), the CPU 60 continues its assessment until the user selects a layout template.

In step S102, the CPU 60 acquires the selected layout template from the template database 11. In these explanations, it is assumed that the selected layout template is the one illustrated in FIG. 4. The layout template includes layout information concerning four objects, i.e. Text 1, Image 1, Image 2, and Text 2. This layout template includes the information “Category=title”, “Importance=High”, “align=Top-Left”, and “font size=96 pt” as layout information for Text 1. Moreover, the layout template includes the information “Category=subimage”, “Importance=Low”, and “align=Top-Left” as layout information for Image 1. In addition, the layout template includes the information “Category=Main image”, “Importance=High”, and “align=Top-Left” as layout information for Image 2. Furthermore, the layout template includes the information “Category=text”, “Importance=Middle”, “align=Top-Left”, and “font size=16 pt” as layout information for Text 2.

In step S104, based on the selection instructions acquired via the input device 74, the CPU 60 determines whether the user has selected the required number of objects. If it is determined that the user has selected the required number of objects (“Yes” in Step S104), the CPU 60 transfers processing to step S106. If it is determined that the user has not selected it (“No” in Step S104), the CPU 60 continues its assessment until the user selects the objects.

In step S106, the CPU 60 acquires the selected objects from the content database 12. Here, as shown in FIG. 5, explanations are given by referring to an example, in which a character string “New Printer Launched” is selected as Text 1, an image of a person is selected as Image 1, a printer image is selected as Image 2, and a character string “New Functionality Strikes Balance Between High-Speed Printing And High Image Quality” is selected as Text 2.

In step S108, the CPU 60 generates an initial layout of the acquired objects in the acquired layout template. The initial layout determines the placement of the objects. As shown in FIG. 6, in the initial layout, a portion of Text 1 and a portion of Image 1 overlap. Moreover, a portion of Image 1 and a portion of Image 2 overlap as well.

In step S110, the CPU 60 generates document attribute information based on the initially laid-out objects.

In step S112, the CPU 60 stores the generated document attribute information in a storage area corresponding to the document attribute information storage module 14 of the external storage unit 70.

In step S114, the CPU 60 executes layout adjustment processing that adjusts the layout information of the initially laid-out objects based on the document attribute information.

In step S116, the CPU 60 determines whether the layout adjustment processing is complete. If it is determined that the layout adjustment processing is complete (“Yes” in Step S116), the CPU 60 transfers processing to Step S118. If it is determined that the layout adjustment processing is not complete (“No” in Step S116), the CPU 60 executes layout adjustment processing until it is finished.

In step S118, the CPU 60 acquires design expertise information from the design expertise information storage module 18. Based on the acquired design expertise information and document attribute information, the CPU 60 executes the design processing of the document that has undergone layout adjustment.

In step S120, the CPU 60 generates document attribute information based on the document that has undergone design processing. The CPU 60 updates document attribute information stored in the document attribute information storage module 14 using the generated document attribute information.

In step S122, the CPU 60 determines whether the design processing is complete. The CPU 60 transfers processing to step S124 if it is determined that design processing is complete (“Yes” in Step S122). If it is determined that design processing is not complete (“No” in Step 122), the CPU 60 executes design processing until it is finished.

In step S124, the CPU 60 outputs the document that has undergone design processing to the output device 72. After the document is outputted to the output device 72, the CPU 60 terminates processing.

1.2.1. Document Attribute Information Generation Processing

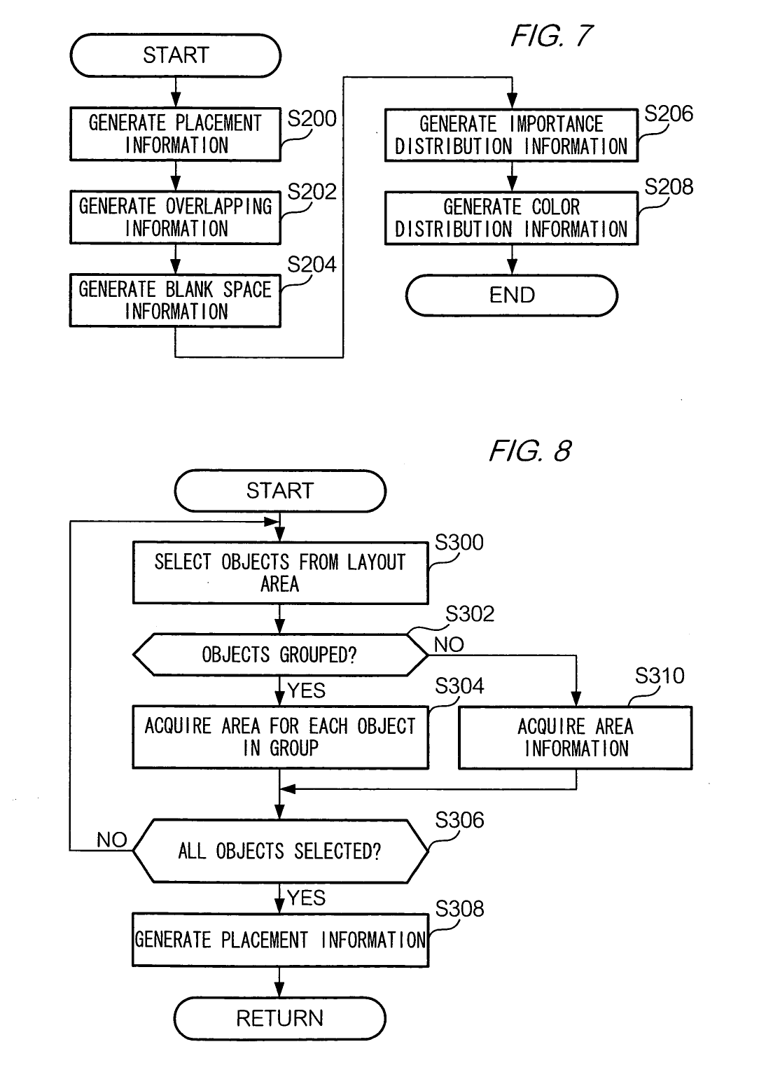

FIG. 7 is a flowchart showing details of document attribute information generation processing performed in step S110. In step S200, the CPU 60 generates placement information. The placement information describes the placement of each object in the layout area. In this embodiment, the placement information includes shape information describing the shape of the objects and coordinate information describing their coordinates.

In step S202, the CPU 60 generates overlapping information. The overlapping information illustrates the overlapping of objects laid out in the layout area. In this embodiment, the overlapping information includes information describing the number of overlapping objects, information describing the area of the overlapping portions, etc. Moreover, the overlapping information may include coordinate information necessary for identifying the shape of the overlapping areas. For example, when the overlapping area is a polygon, the overlapping information may include the coordinates of its vertices.

In step S204, the CPU 60 generates blank space information. The blank space information describes blank space, i.e. areas other than the areas occupied by the objects within the layout area. The blank space information includes, For example, information identifying polygons if the blank spaces are approximated with polygons (or instance, the coordinates of the vertices of the polygons), or information identifying ellipses if the blank spaces are approximated with ellipses (For example, the coordinates of the centers of the ellipses, the length of their minor axes and major axes). The blank spaces information include information that specifies, For example, a plurality of polygons.

In step S206, the CPU 60 generates importance distribution information. The importance distribution information describes the distribution of the importance of the objects laid out in the layout area. In this embodiment, the importance distribution information includes importance information on the respective objects and their area information. The term “area information” refers to information identifying a portion of the area within the layout area, For example, to coordinate values in a two-dimensional coordinate system.

In step S208, the CPU 60 generates color distribution information. The color distribution information describes color distributions within the layout area. In this embodiment, the color distribution information includes the representative colors of the objects and their area information. The term “representative color” refers to colors derived from the color information included in the objects in accordance with a predetermined algorithm. When the processing of steps S200-S208 is finished, the CPU 60 terminates the processing shown in FIG. 7.

1.2.1.1 Placement Information Generation Processing

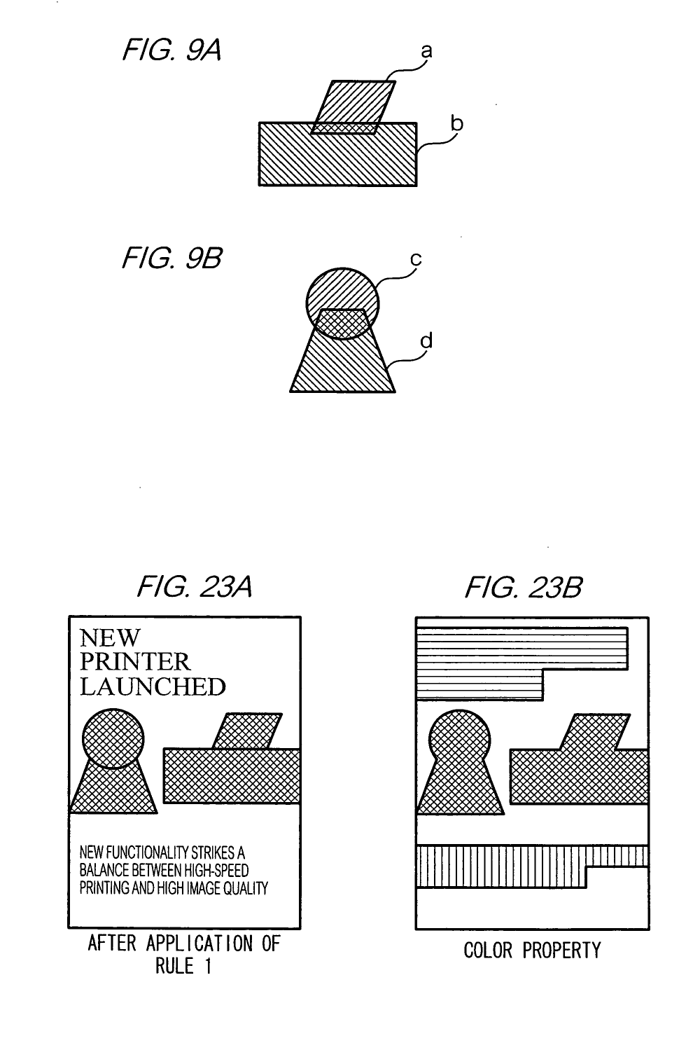

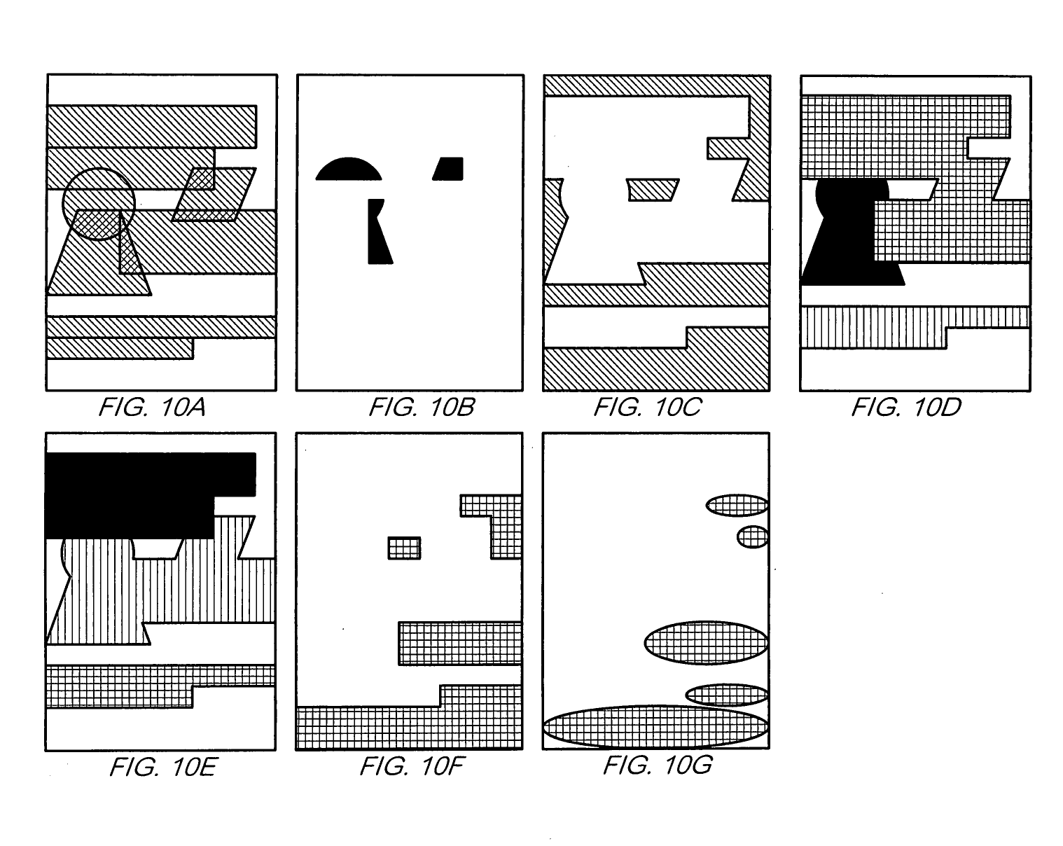

FIG. 8 shows details of placement information generation processing carried out in Step S200. FIGS. 9A and 9B illustrate grouped objects. FIGS. 10A-10G provides a visual representation of document attribute information.

In step S300, the CPU 60 selects the target objects to be processed among the objects laid out in the layout area. In step S302, the CPU 60 determines whether the target objects are grouped. If it is determined that the target objects are grouped (“Yes” in Step S302), the CPU 60 transfers processing to Step S304. If it is determined that the target objects are not grouped (“No” in Step S302), the CPU 60 transfers processing to step S310.

In step S304, the CPU 60 acquires area information respectively for each object included in the group. In this embodiment, as shown in FIG. 9B, the image of a person was formed by grouping two images, i.e. image c and image d. Moreover, as shown in FIG. 9A, the image of a printer was formed by grouping two images, image a and image b. Therefore, the CPU 60 acquires area information for image c and image d in case of the image of a person and area information for image a and image b in case of the image of a printer. In addition, the CPU 60 acquires area information for text objects on a line-by-line basis. For example, in the example illustrated in FIG. 6, when working with the text “New Printer Launched”, the CPU 60 acquires area information for the text “New Prin” in the first line and area information for the text “ter Launched” in the second line, respectively. In other words, the CPU 60 handles the text “New Printer Launched” as an object produced by grouping the two text strings “New Prin” and “ter Launched”.

In step S306, the CPU 60 determines whether acquisition of area information for all the objects laid out in the layout area is complete. If it is determined that the acquisition of area information for all the objects is complete (“Yes” in Step S306), the CPU 60 transfers processing to step S308. If it is determined that the acquisition of area information for all the objects is not complete (“No” in Step S306), the CPU 60 transfers processing back to step S300.

In step S308, based on the acquired area information, the CPU 60 generates placement information. For example, if an object is an image, the corresponding placement information includes shape information describing the shape of the image (circle, polygon, ellipse, etc.) and coordinate information describing coordinates that represent the geometric figure (the coordinates of the center of a circle, the vertices of a polygon, etc.). Moreover, if the object is text, the placement information includes shape information and coordinate information concerning the text box. A text box is a figure that defines the location, where a text object is placed. FIG. 10A provides a visual representation of placement information for the initial layout illustrated in FIG. 6. In the example of FIG. 10A, the shape of the area where the text is laid out is rectangular.

In step S310, the CPU 60 acquires area information for the selected objects.

1.2.1.2. Overlapping Information Generation Processing

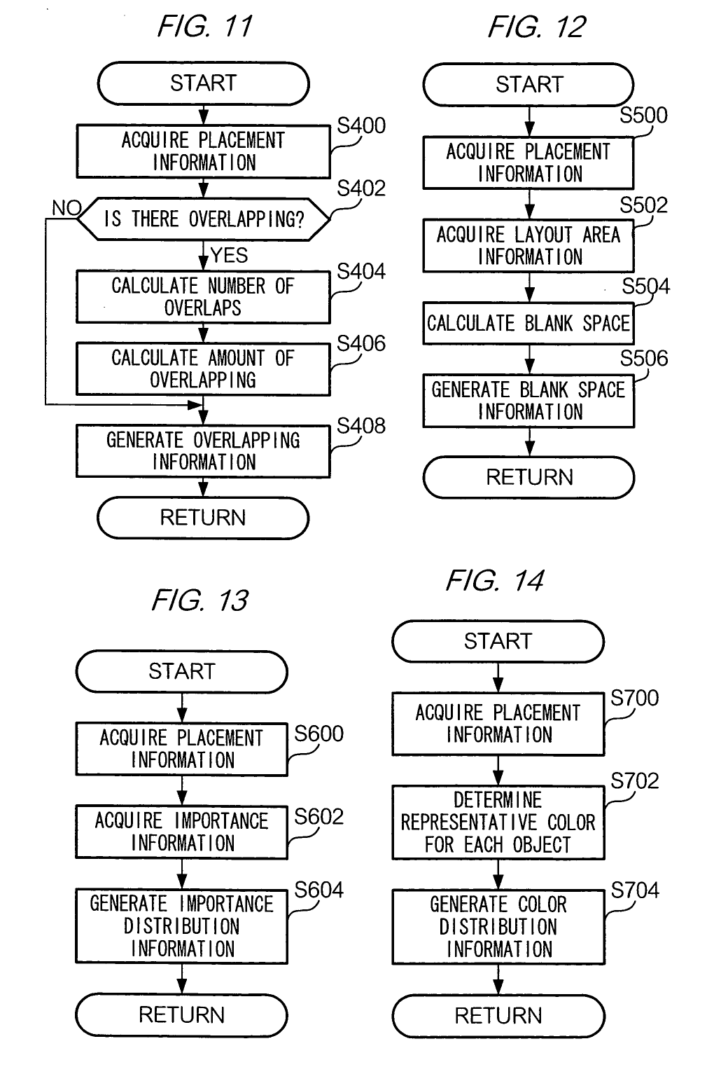

FIG. 11 is a flowchart showing details of overlapping information generation processing carried out in step S202. In step S400, the CPU 60 acquires placement information generated during placement information generation processing. In step S402, the CPU 60 assesses the presence of overlapping objects within the layout area. If it is determined that there are overlapping objects within the layout area (“Yes” in Step S402), the CPU 60 transfers processing to step S404. If it is determined that there are no overlapping objects within the layout area (“No” in Step S402), the CPU 60 transfers processing to step S408.

In step S404, based on the placement information, the CPU 60 calculates the number of objects overlapping with other objects. In step S406, the CPU 60 calculates the coordinates describing the overlapping area of the overlapped objects. In step S408, the CPU 60 generates overlapping information based on the number of overlaps and overlap coordinates. FIG. 10B provides a visual representation of the generated overlapping information. It should be noted that when there are no overlapping objects within the layout area, the CPU 60 generates overlapping information describing absence of overlapping. Also, it should be noted that CPU60 does not generate overlapping information for grouped objects belonging to the same group.

1.2.1.3. Blank Space Information Generation Processing

FIG. 12 is a flowchart showing details of blank space information generation processing carried out in step S204. In step S500, the CPU 60 acquires the placement information generated during placement information generation processing. In step S502, the CPU 60 acquires layout area information. Here, the term layout area information refers to range information concerning a single-page area if the layout area is a single page, to range information concerning a multi-page area if the layout area is a plurality of pages, to range information on a single-section area if the layout area is a single section; and to range information concerning a multi-section area if the layout area is a plurality of sections. The range information specifies a physical range, i.e. an area, on printing paper, a display device, or other output media.

In step S504, based on the placement information and range information, the CPU 60 calculates coordinates describing blank spaces. In step S506, based on the blank space coordinates, the CPU 60 generates blank space information. In this embodiment, the blank space information may be generated by approximating blank spaces using polygons, ellipses, or combinations thereof. FIG. 10C provides a visual representation of blank spaces. The blank spaces are in a mutually exclusive relationship relative to the areas (FIG. 10A) designated by the placement information. FIG. 10F provides a visual representation of the blank spaces approximated with polygons (rectangles). FIG. 10G provides a visual representation of the blank spaces approximated with ellipses. It should be noted that blank spaces and areas designated by placement information are not necessarily in a mutually exclusive relationship. For example, a certain area may belong both to a blank space and to an area specified by placement information. Alternatively, there may exist areas that belong neither to blank spaces nor to areas specified by placement information.

1.2.1.4. Importance Distribution Information Generation Processing

FIG. 13 is a flowchart showing details of importance distribution information generation processing carried out in Step 206. In Step 600, the CPU 60 acquires the placement information generated during placement information generation processing. In step S602, the CPU 60 acquires importance information corresponding to layout areas in the layout template. As described above, the layout template includes importance information describing the importance of each area.

In step S604, based on the placement information and importance information, the CPU 60 generates importance distribution information. Here, the term “importance distribution information” refers to information describing the distribution of the importance of objects in the layout area. The importance distribution information includes the importance of each object and information on the placement of the objects. When N objects are placed, the importance distribution information includes N data sets including information concerning the importance of the objects and the placement of the objects. In this embodiment, importance is indicated using 3 levels: “High”, “Middle”, and “Low”. It should be noted that methods used to describe importance are not limited to the above. Moreover, although in this working example importance preset in advance for each object is used “as is” as the importance distribution information, it is not limited to the method shown above, and such importance distribution information may be calculated from the importance of each object based on a predetermined algorithm. As a result, the importance of the entire layout area can be calculated more accurately. FIG. 10D provides a visual representation of the importance distribution information. In FIG. 10D, objects shown with thicker hatching are of higher importance. The object with the thickest hatching has an importance level of “High”, the object with the thinnest hatching has an importance level of “Low”, and the object with medium-intensity hatching has an importance level of “Middle”.

1.2.1.5. Color Distribution Information Generation Processing

FIG. 14 is a flowchart showing details of color distribution information generation processing carried out in step S208. In step S700, the CPU 60 acquires the placement information generated during placement information generation processing. In step S702, the CPU 60 determines a representative color for each object based on the color information of each object.

In step S704, based on the placement information and representative colors, the CPU 60 generates color distribution information. The term “color distribution information” includes the representative colors of the objects and the information on the placement of the objects. FIG. 10E provides a visual representation of the color distribution information. In FIG. 10E, all the objects are painted their representative colors.

1.2.2. Layout Adjustment Processing

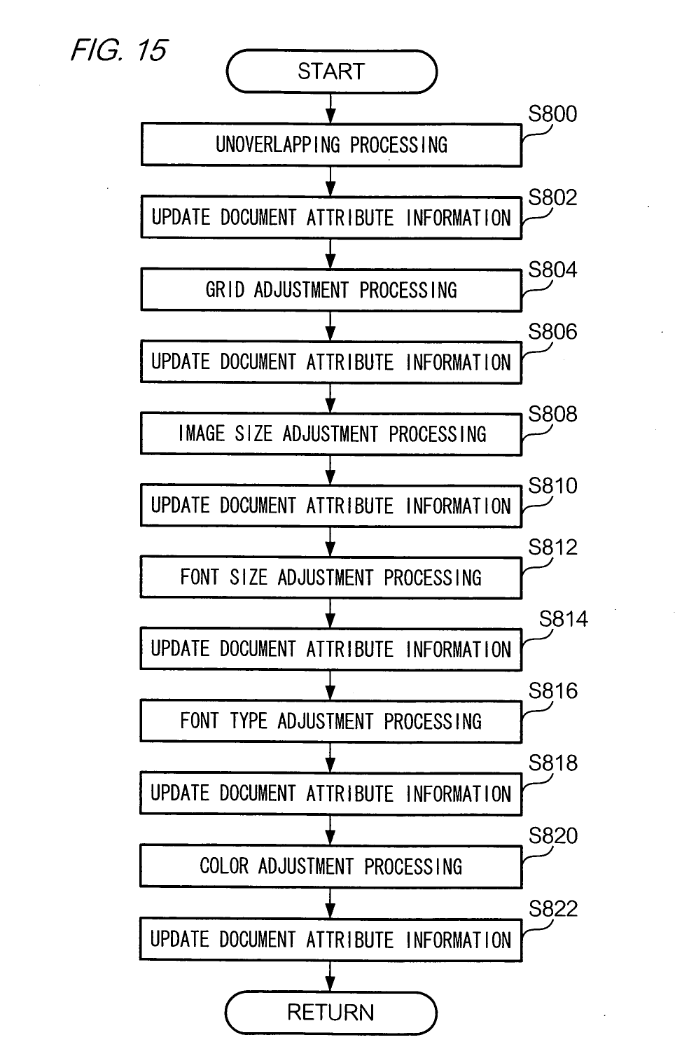

FIG. 15 is a flowchart illustrating details of layout adjustment processing performed in step S114. In step S800, the CPU 60 executes unoverlapping processing for the initially laid-out document. In step S802, the CPU 60 regenerates document attribute information based on the unoverlapped document. Then, the CPU 60 updates the document attribute information stored in the document attribute information storage module 14 using the regenerated document attribute information. Here, the “unoverlapping processing” refers to moving or resizing either one or both objects overlapped within the layout area during initial layout such that there is no more overlapping. Such unoverlapping processing is carried out based on at least one type of document attribute information such as placement information, overlapping information, blank space information, importance distribution information, etc.

In step S804, the CPU 60 performs grid adjustment processing on the document. The grid adjustment processing refers to adjusting the positional relationship of a plurality of objects according to a predetermined rule. For example, grid adjustment is performed as follows. The CPU 60 draws grid lines in the layout area. The position of the grid lines may be predetermined. Alternatively, the position of the grid lines may be determined based on a positional relationship with a specific object. The CPU 60 modifies the location of the objects such that the positional relationship between the representative positions of the objects and the grid lines satisfies certain predetermined conditions. For example, the coordinates of the upper left vertex, or the coordinates of the center etc. are used as the representative location of the object. The condition that the representative location should be located on a grid line, For example, is used as the relation between the grid lines and the representative location. At such time, the position of the grid lines may be set based on blank space information. For example, the CPU 60 may set the position of the grid lines such that the size of the blank space (the proportion of the blank space within the layout area) is kept within a predetermined range.

In step S806, the CPU 60 regenerates document attribute information based on the document produced by grid adjustment. In addition, the CPU 60 updates the document attribute information stored in the document attribute information storage module 14 using the regenerated document attribute information.

In step S808, the CPU 60 performs image size adjustment processing on the document. The image size adjustment processing refers to modifying the size (dimensions) of a plurality of images satisfying certain conditions according to a predetermined rule. For example, the conditions describing a plurality of target objects may be that they have to belong to the same category and their image size proportion has to fall within a predetermined range (e.g. within ±10%). It should be noted that this condition can be set arbitrarily. Moreover, the rule for resizing images may be that the images are resized to the same size. Such processing can prevent aesthetic appearance from being impaired by non-uniform sizes among objects belonging to the same category.

In step S810, the CPU 60 regenerates document attribute information based on the document produced as a result of such image size adjustment processing. In addition, the CPU 60 updates the document attribute information stored in the document attribute information storage module 14 using the regenerated document attribute information.

In step S812, the CPU 60 performs font size adjustment processing on the document. The font size adjustment processing refers to processing, during which the font size of text satisfying certain conditions is modified according to a predetermined rule. For example, the item to be processed may be a plurality of text items belonging to the same category. If their font sizes are different, the CPU 60 changes their font sizes to the same value. In another example, the item to be processed may be, For example, a text item that does not fit into a text box frame because its font size is too large. In such a case, the CPU 60 reduces the font size such that the text fits into the text box frame. In yet another example, the item to be processed may be, For example, a text item, whose letters occupy a region with a surface area smaller than a certain threshold value relative to the text box, in other words, whose font size is too small for the text box. In such a case, the CPU 60 increases the font based on the range included in the frame of the text box. Such font size adjustment processing can impart a sense of unity to the layout of the document.

In step S814, the CPU 60 regenerates document attribute information based on the document produced as a result of such font size adjustment processing. Furthermore, the CPU 60 updates the document attribute information stored in the document attribute information storage module 14 using the regenerated document attribute information.

In step S816, the CPU 60 performs font type adjustment processing on the document. The font type adjustment processing refers to modifying the font (type of font) in a text satisfying certain conditions in accordance with a predetermined rule. The item to be processed may be, For example, a plurality of text items belonging to the same category. If their fonts are different, the CPU 60 changes the fonts of these text items to the same font. For example, the CPU 60 selects any of the fonts used before the modification as the post-modification font. Alternatively, the CPU 60 sets a predetermined font as the post-modification font. Such font type adjustment processing can impart a sense of unity to the layout of the document.

In step S818, the CPU60 regenerates document attribute information based on the document produced as a result of such font type adjustment processing. In addition, the CPU 60 updates the document attribute information stored in the document attribute information storage module 14 using the regenerated document attribute information.

In step S820, the CPU 60 performs color adjustment processing on the document. The color adjustment processing refers to processing that involves modifying the colors of a plurality of objects satisfying certain conditions in accordance with a predetermined rule. The objects to be processed may be, For example, a plurality of objects, for which the color difference between their representative colors falls outside of a predetermined range. In such a case, the CPU 60 modifies the colors of the objects such that the color difference between the representative colors of these objects falls within the predetermined range. Such color adjustment processing can impart a sense of unity to the layout of the document. It should be noted that when coloring rules are specified in the template, the CPU 60 may adjust colors in accordance with such coloring rules.

In step S822, the CPU 60 regenerates document attribute information based on the document produced as a result of such color adjustment processing. In addition, the CPU 60 updates the document attribute information stored in the document attribute information storage module 14 using the regenerated document attribute information.

1.2.2.1. Unoverlapping Processing

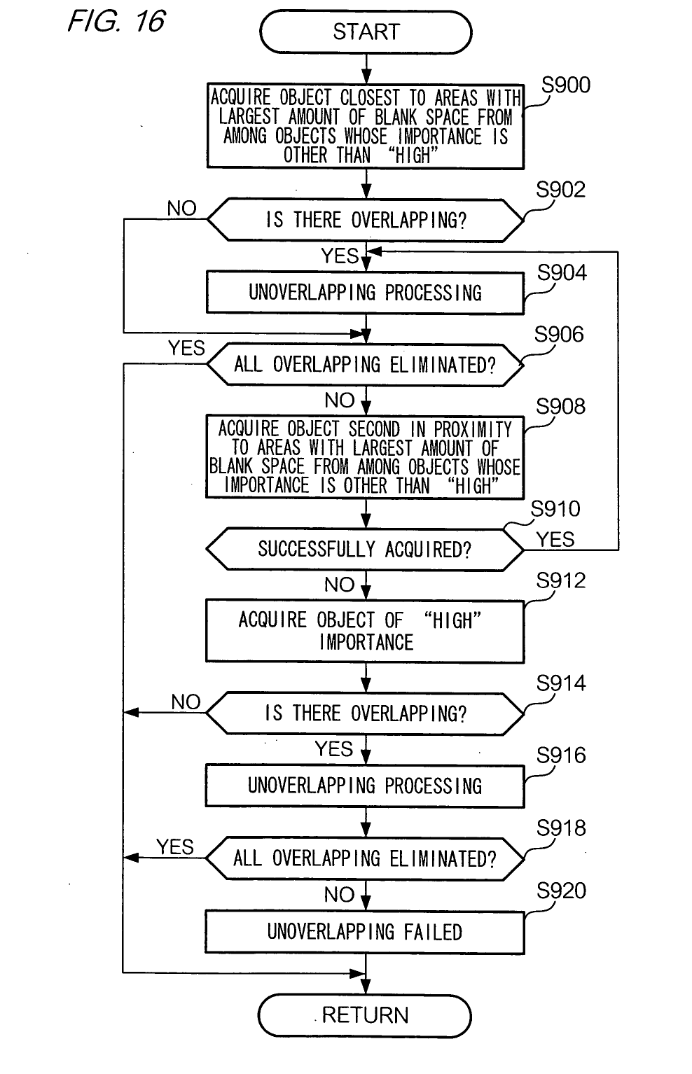

FIG. 16 is a flowchart illustrating details of unoverlapping processing performed in Step S800. In Step S900, based on importance distribution information and blank space information, the CPU 60 identifies, as target objects, objects whose importance is not “High” and which are closest to blank spaces with the largest surface area among the objects laid out in the layout area. In step S902, the CPU 60 determines whether the target objects overlap with other objects. If it is determined that the target objects overlap with other objects (“Yes” in Step S902), then the CPU 60 transfers processing to Step S904. If it is determined that the target objects do not overlap with other objects (“No” in Step S902), then the CPU 60 transfers processing to Step S906.

In step S904, the CPU 60 performs unoverlapping processing on the target objects. In Step S906, the CPU 60 determines whether all overlapping in the layout area has been eliminated. If it is determined that all the overlapping in the layout area has been eliminated (“Yes” in Step S906), then the CPU 60 terminates the processing shown in FIG. 16. If it is determined that not all the overlapping in the layout area has been eliminated (“No” in Step S906), then the CPU 60 transfers processing to Step S908.

In Step S908, the CPU 60 identifies, as target objects, objects whose importance is not “High” and whose surface area, as compared with the previous target object, is second in proximity to the largest blank space among the objects laid-out in the layout area. In Step S910, the CPU 60 determines whether a target object could be identified in step S908. If it is determined that a target object could be identified (“Yes” in Step S910), then the CPU 60 again transfers processing to Step S904. If it is determined that no target object could be identified (“No” in Step S910), then the CPU 60 transfers processing to Step S912.

In Step S912, the CPU 60 identifies an object of “High” importance among the objects laid-out in the layout area as the target object. If there is a plurality of objects of “High” importance, the CPU 60 identifies target objects one by one in accordance with a predetermined rule. In Step S914, based on overlapping information, the CPU 60 determines whether the target object overlaps with other objects. If it is determined that the target object overlaps with other objects (“Yes” in Step S914), the CPU 60 transfers processing to step S916. If it is determined that the target object does not overlap with other objects (“No” in Step S914), the CPU 60 terminates the processing shown in FIG. 16.

In Step S916, the CPU 60 performs unoverlapping processing on the target object. In Step S918, the CPU 60 determines whether all overlapping in the layout area has been eliminated. If it is determined that all overlapping in the layout area has been eliminated (“Yes” in Step S918), the CPU 60 terminates the processing shown in FIG. 16. If it is determined that not all overlapping in the layout area has been eliminated (“No” in Step S918), the CPU 60 generates information to the effect that the unoverlapping processing has failed. The CPU 60 terminates the processing shown in FIG. 16.

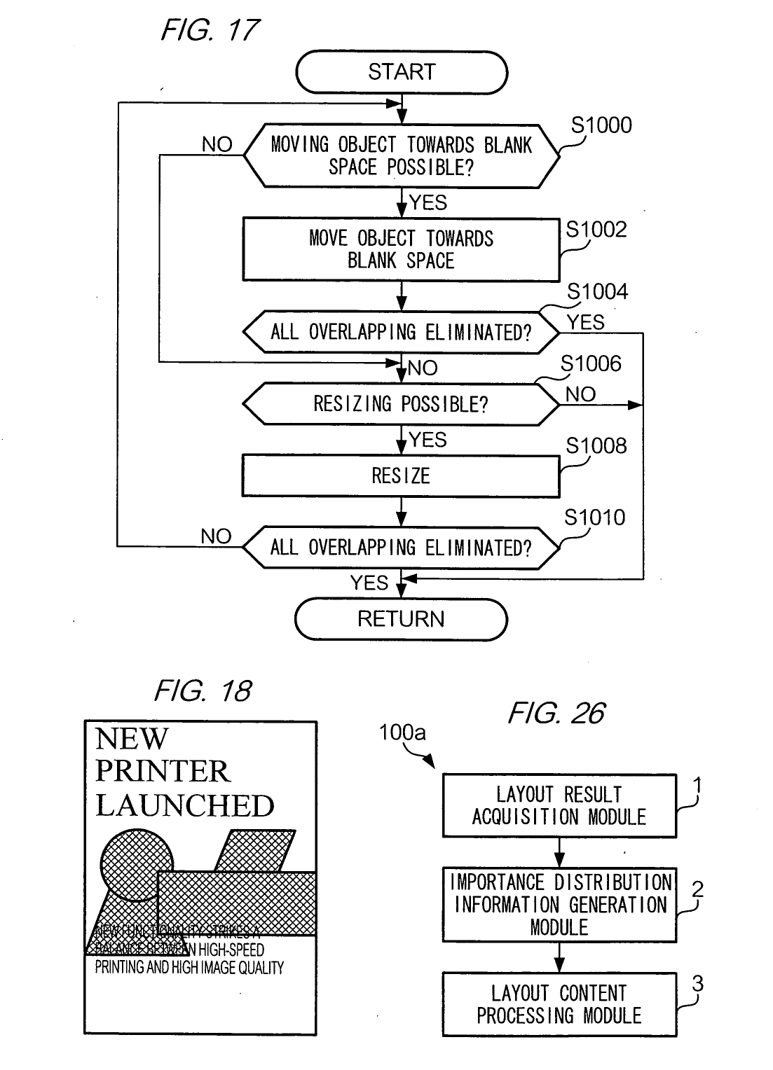

FIG. 17 is a flowchart illustrating details of the unoverlapping processing performed in Step S904 and Step S916. In Step S1000, the CPU 60 determines whether target objects can be moved in the direction of the blank space. For example, the rules of moving may be predetermined. The CPU 60 determines whether the target objects can be moved in accordance with these rules. If it is determined that they can be moved in the direction of the blank space (“Yes” in Step S1000), the CPU 60 transfers processing to Step S1002. If it is determined that they cannot be moved in the direction of the blank space (“No” in Step S1000), the CPU 60 transfers processing to Step S1006.

In Step S1006, the CPU 60 determines whether the target object can be resized. For example, the object or layout information includes a flag indicating whether the object can be resized. Based on the flag, the CPU 60 determines whether resizing is possible. Alternatively, the CPU 60 uses a predetermined rule to determine whether the object can be resized. If it is determined that the target object can be resized (“Yes” in Step S1006), the CPU 60 transfers processing to Step S1008. If it is determined that the target object cannot be resized (“No” in Step S1006), the CPU 60 terminates the processing shown in FIG. 17.

In Step S1008, the CPU 60 resizes the target object based on a predetermined rule. For example, the CPU 60 changes the reduction ratio by a predetermined amount of change. Specifically, the CPU 60 changes the reduction ratio ten points at a time: 90%, 80%, 70%, . . . . A lower boundary may be set up for the reduction ratio. Alternatively, the CPU 60 may change the font size of a text object such that the font size obtained after reduction matches a font size belonging to a group of predetermined font sizes. For example, if the values that the font sizes can assume are set to “ . . . , 8, 9, 10, 10.5, 11, 12, 14, 16, 18, 20, 22, 24, . . . ”, the CPU 60 reduces the font to a font size that is one step smaller than the font size before the reduction.

In Step S1010, the CPU 60 determines whether all the overlapping of the target objects has been eliminated. If it is determined that all the overlapping of the target objects has been eliminated (“Yes” in Step S1010), the CPU 60 terminates the processing shown in FIG. 17. If it is determined that not all the overlapping of the target objects has been eliminated (“No” in Step S1010), the CPU 60 again transfers processing to Step S1000. In other words, when an object can be moved in the direction of the blank space by changing its size, an attempt is made to eliminate overlapping by moving. When moving is impossible, the size of the objects is reduced one step at a time towards the lower boundary value of size reduction, and an attempt is made to eliminate overlapping combined with moving.

1.3. Specific Examples

First of all, in accordance with user instructions, the CPU 60 of the document production apparatus 100 acquires a template from the template database 11. Then, in accordance with user instructions, the CPU 60 acquires objects to be placed into the template from a content database 12 (Steps S100-S106). Here, explanations are provided regarding an exemplary case, wherein the acquired layout template is the one shown in FIG. 4 and the acquired objects are the ones shown in FIG. 5. In other words, the CPU 60 acquires an image of a person as Image 1, an image of a printer as Image 2, a text string “New Printer Launched” as Text 1, and a text string “New Functionality Strikes A Balance Between High-Speed Printing And High Image Quality” as Text 2. Next, the CPU 60 places the acquired objects into the acquired layout template (Step S108).

FIG. 18 illustrates an exemplary initial document layout. As shown in FIG. 18, in the initial layout of the document, part of Image 1 and part of Image 2 overlap, and part of Text 2 overlaps with Image 1 in its lower portion.

Based on the document, the CPU 60 generates five types of document attribute information: placement information, overlapping information, blank space information, importance distribution information, and color distribution information (Step S110, Steps S200-S208). It should be noted that the layout template illustrated in FIG. 4 has a single-page layout area.

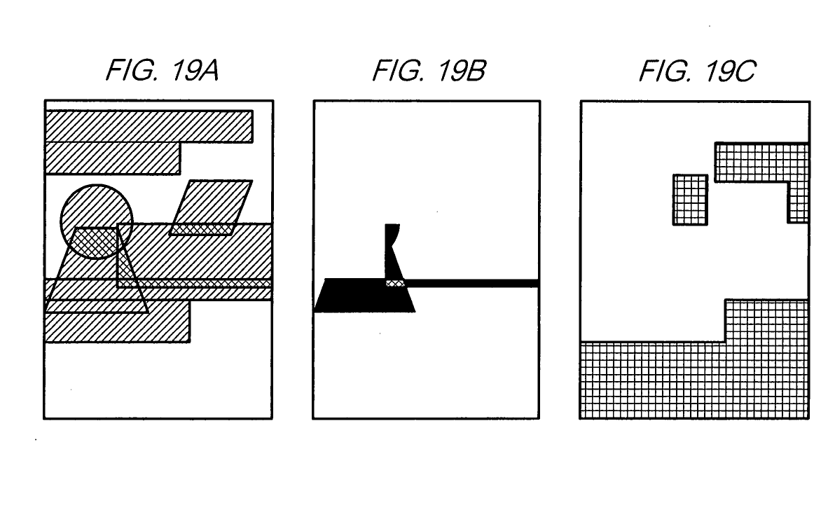

FIG. 19A-19C provides a visual representation of the document attribute information of the document of FIG. 18. FIG. 19A is a visual representation of placement information. Placement information corresponding to Text 1 and Text 2 is generated in the form of text boxes for each line of text laid out in the layout area. Placement information corresponding to Image 1 and Image 2 is generated for each object (a-d), as shown in FIG. 9. FIG. 19B is a visual representation of overlapping information. Because the text placement information is generated in the form of text boxes, overlapping information is generated accordingly. FIG. 19C provides a visual representation of blank space information. FIG. 19C illustrates an example, in which blank spaces are approximated with polygons. In this example, in particular, there is a large blank space at the bottom of the layout area.

Next, based on the document attribute information, the CPU 60 executes layout adjustment processing (Step S114). The first operation performed during the layout adjustment processing consists in unoverlapping processing (Step S800). During the unoverlapping processing, the CPU 60 identifies, as target objects, objects whose importance is not “High” and which are closest to the regions with the largest blank space area among the objects laid-out in the layout area (Step S900). As shown in FIG. 19C, the region with the largest blank space is located in the lower portion of the layout area. Therefore, the CPU 60 identifies Text 2 (“New Functionality Strikes A Balance Between High-Speed Printing And High Image Quality”), which is closest to this region and has an importance of “Middle”, as the target object. As shown in FIG. 19B, Text 2 has an overlapping portion between Image 1 and Image 2. Accordingly, the CPU 60 performs unoverlapping processing (Step S904).

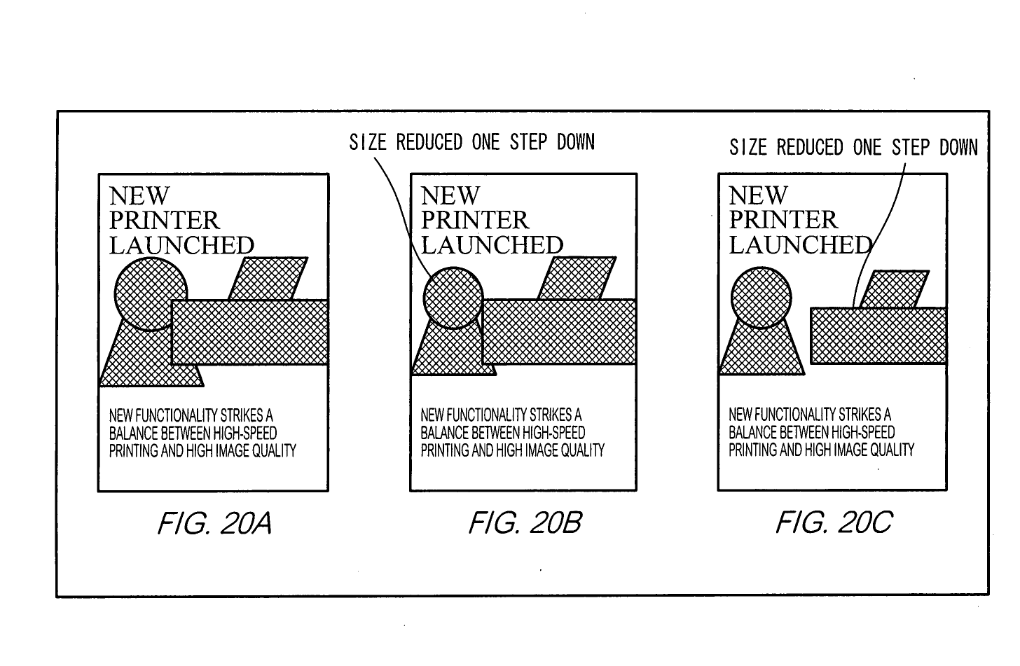

FIGS. 20A-20C illustrates an example of unoverlapping processing. During the unoverlapping processing, based on blank space information and placement information concerning Text 2, the CPU 60 determines whether Text 2 can be moved to the blank space at the bottom of the layout area (Step S1000). Because in this case there is a sufficiently ample blank space, the assessment is that Text 2 can be moved. The CPU 60 moves Text 2 in the direction of the blank space at the bottom of the layout area (Step S1002). FIG. 20A illustrates the document after Text 2 has been moved. Because doing so removes all overlapping in Text 2 (“Yes” in Step S1004) the CPU 60 assesses that all overlapping in the layout area has been removed (Step S906).

As illustrated in FIG. 20A, after moving Text 2, Image 1 and Image 2 overlap (“No” in Step S906). Consequently, the CPU 60 identifies, as target objects, objects whose importance is other than “High” and which are located in positions that are second in proximity to the space with the largest area in comparison with the previous target objects among the objects laid out in the layout area (step S908). In this case, Image 1, which has an importance of “Low”, is identified as the target object (“Yes” in Step S910). The CPU 60 executes unoverlapping processing on Image 1 (Step S904). Because there is no blank space to move Image 1 to (“No” in Step S1000), the CPU 60 determines whether Image 1 permits resizing or not. Here, the flag of Image 1 shows that a resizing is possible (“Yes” in Step S1006). Therefore, the CPU 60 reduces the size of Image 1 one level (Step 1008). FIG. 20B illustrates the document after resizing Image 1. As shown in FIG. 20B, even after resizing, the overlapping in Image 1 is not eliminated (“No” in Step S1010). Therefore, the CPU 60 again determines whether it is possible to move Image 1 to a blank space. Because here it is impossible to move it away (“No” in Step S100), the CPU 60 determines whether further resizing is possible. Here, the flag of Image 1 shows that further resizing is impossible (“No” in Step S1006). Therefore, the CPU 60 terminates the unoverlapping processing on Image 1. Because there are no other objects with an importance other than “High” that would satisfy the requirements for target objects (“No” in Step S910), the CPU 60 identifies an object having an importance of “High” as a target object. There are two objects with an importance of “High”: Text 1 and Image 2. Because of these, Image 2 is the object that overlaps with other objects, the CPU 60 identifies Image 2 as the target object. The CPU 60 performs unoverlapping processing on Image 2 (Step S916). Because Image 2 cannot be moved to a blank space (“No” in Step S1000), the CPU 60 determines whether Image 2 can be resized. Because here the flag of Image 2 shows that resizing is possible (“Yes” in Step S1006), the CPU 60 reduces the size of Image 2 one level (Step S1008). FIG. 20C illustrates the document after resizing Image 2. As shown in FIG. 20C, reducing the size of Image 2 eliminates overlapping in Image 2 (“Yes” in Step S1010). The CPU 60 terminates the unoverlapping processing on the objects of Image 2.

Because all the overlapping in the layout area has been eliminated by the above-described processing (“Yes” in Step 906), the CPU 60 terminates the unoverlapping processing. When the unoverlapping processing is over, the CPU 60 generates document attribute information based on the document obtained at this point in time. The CPU 60 updates the contents of the document attribute information storage module 14 using the generated document attribute information (step S802).

Furthermore, as part of layout adjustment processing, the CPU 60 performs grid adjustment processing, image size adjustment processing, font size adjustment processing, font type adjustment processing, and color adjustment processing. In addition, the CPU 60 updates the document attribute information after every round of adjustment processing (Steps S804-S822)).

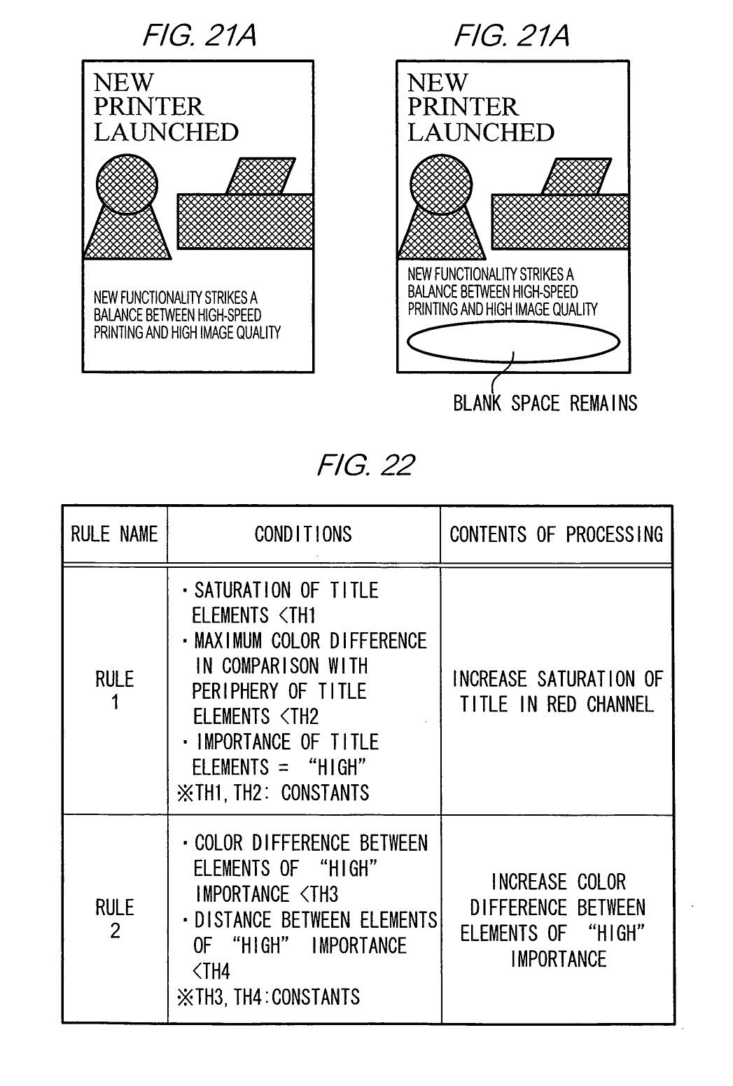

FIG. 21A illustrates an exemplary document obtained after layout adjustment processing in the invention. As shown in FIG. 21A, the overlapping of objects in the document obtained as a result of the above-described layout processing operations has been eliminated. In addition, Text 2 has been moved to the blank space that existed in the layout area at the time of the initial layout and the balance of object placement has been improved.

FIG. 21B illustrates an exemplary document obtained after layout adjustment processing in the related art. In the related art, blank space balance is not considered, and overlapping is eliminated in the order of lower importance. Therefore, as shown in FIG. 21B, a large blank space is left in the bottom portion of the layout area. The balance of placement between the objects is relatively poor as compared with the one obtained with the invention.

When the layout adjustment processing is over (“Yes” in Step S116), the CPU 60 performs design processing on the document based on the design expertise information stored in the design expertise information storage module 18 (step S118).

FIG. 22 illustrates an example of design expertise information. In the present embodiment, the design expertise information includes two rules shown in FIG. 22. The rules include conditions of application and the corresponding processing. The CPU 60 determines whether the document satisfies the conditions of application of the design expertise information. Specifically, the CPU 60 determines whether the document satisfies, respectively, Rule 1 and Rule 2. The rule whose conditions are satisfied is applied to the document by the CPU 60.

In FIG. 22, TH1 represents a threshold saturation value for the title. TH2 represents a threshold value for the maximum color difference between the title and objects around it. TH3 represents a threshold value for the color difference between the plurality of objects with an importance of “High”. TH4 represents a threshold value for the distance between the plurality of objects with an importance of “High”.

In the example illustrated in FIG. 22, Rule 1 includes the conditions that (1) the saturation of objects laid out in the title placement area is lower than a threshold value, TH1, (2) the maximum color difference between objects laid out in the title placement area and objects around them is lower than a threshold value, TH2, and (3) the title has an importance of “High”. If these conditions are met, the CPU 60 processes the title (in this example, “New Printer Launched”) to increase its saturation in the red channel.

In addition, Rule 2 includes the conditions that (1) the color difference between the plurality of objects with an importance of “High” is lower than a threshold value, TH3, and (2) the distance between the two objects with an importance of “High” is lower than a threshold value, TH4. If these conditions are met, the CPU 60 performs design processing that increases the color difference between the plurality of objects with an importance of “High” (in this example, the character string “New Printer” and the character string “New Functionality Strikes Balance Between High-Speed Printing And High Image Quality”).

Specifically, the CPU 60, first of all, determines whether the document satisfies the conditions of application of Rule 1. If the conditions of application are met, the CPU 60 increases the saturation of the title in the red channel (e.g. makes the color of title text red). Next, the CPU 60 determines whether the document satisfies the conditions of application of Rule 2. If Rule 1 has been applied, it makes an assessment as to whether the document obtained as a result of application of Rule 1 satisfies the conditions of application. For example, Rule 2 is not applied to a document that no longer satisfies the conditions of Rule 2 after application of Rule 1. As another example, Rule 2 is not applied if the color difference relative to the printer image with an importance of “High” has been increased as a result of modifying the color of the title text.

FIG. 23A illustrates an exemplary document obtained after design processing. FIG. 23B provides a visual representation of updated color distribution information after design processing. Because the color of the letters of the title (character string “New Printer”) has been changed to red, the color distribution information corresponding to the title (representative color) is also updated to red (Step S120). It should be noted that detailed explanations regarding processing used to increase saturation and processing used to increase color difference are omitted here because they can be easily implemented using well-known technologies.

When the design processing is over (“Yes” in Step S122), the CPU 60 outputs the document from the output device 72 (Step S124). For example, the document is displayed on an LCD or a CRT display, etc. Alternatively, the document is printed out using a printer unit.

According to the present embodiment, the layout of the document is adjusted based on the document attribute information. Furthermore, the document undergoes design processing based on the design expertise information. As a result, a document with excellent visibility and high design characteristics can be prepared in a straightforward manner.

In addition, the document is provided to the user via an output device 72. Therefore, the user can visually determine which objects are laid out and what the relationships between the objects are. The user can correct the contents of the layout by using it as a guide. In this manner, the document production apparatus 100 can support the design process of the user.

1.4. Modified Examples

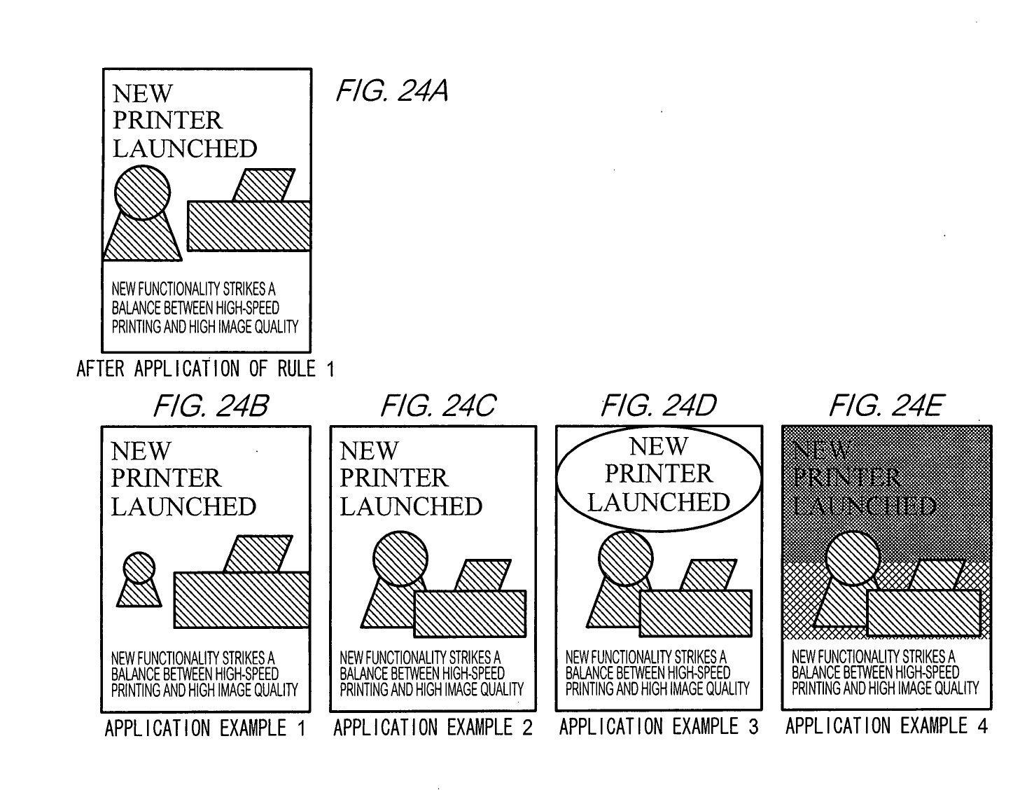

FIGS. 24A-24E shows a modified example of the design expertise information. The design expertise information is not limited to the information illustrated in FIG. 22. Other rules may be used as the design expertise information. FIGS. 24A-24E shows four application examples 1-4 as additional modified examples of the design expertise information.

Application example 1 (FIG. 24B) is an example, wherein the apparent relative size ratio of the images (enlargement ratio or percent increase in enlargement ratio) is modified depending on the degree of importance. Based on this rule, images of higher importance are enlarged and images of lower importance are made smaller. Therefore, this rule allows images of higher importance to stand out.

Application example 2 (FIG. 24C) illustrates an example obtained by applying a rule, in accordance with which objects are made to overlap in such a manner that objects of higher importance are brought forward and objects of lower importance are sent backward. The amount of overlapping is determined by the rule. Based on the rule, objects of higher importance are displayed in the foreground, which allows for improving the sense of image unity.

Application example 3 (FIG. 24D) illustrates an example obtained by applying a rule, in accordance with which a geometric figure (e.g. an oval) is inserted in the background of the object with the highest degree of importance (in this case, the title). The shape and color of the geometric figure is determined by the rule. Based on the rule, the visibility of the object with the highest importance can be improved.

Application example 4 (FIG. 24E) illustrates an example obtained by applying a rule, in accordance with which a predetermined background (e.g. a gradient image) is inserted throughout the entire layout area. The image inserted as the background is determined by the rule. The rule may include, For example, setting the color of the gradient in accordance with the color of the title. Based on the rule, the background image can determine the appearance of the entire layout area and improve the visibility of the title. It should be noted that because it is difficult to show gradation in the figures, the gradation is not shown in FIG. 24E.

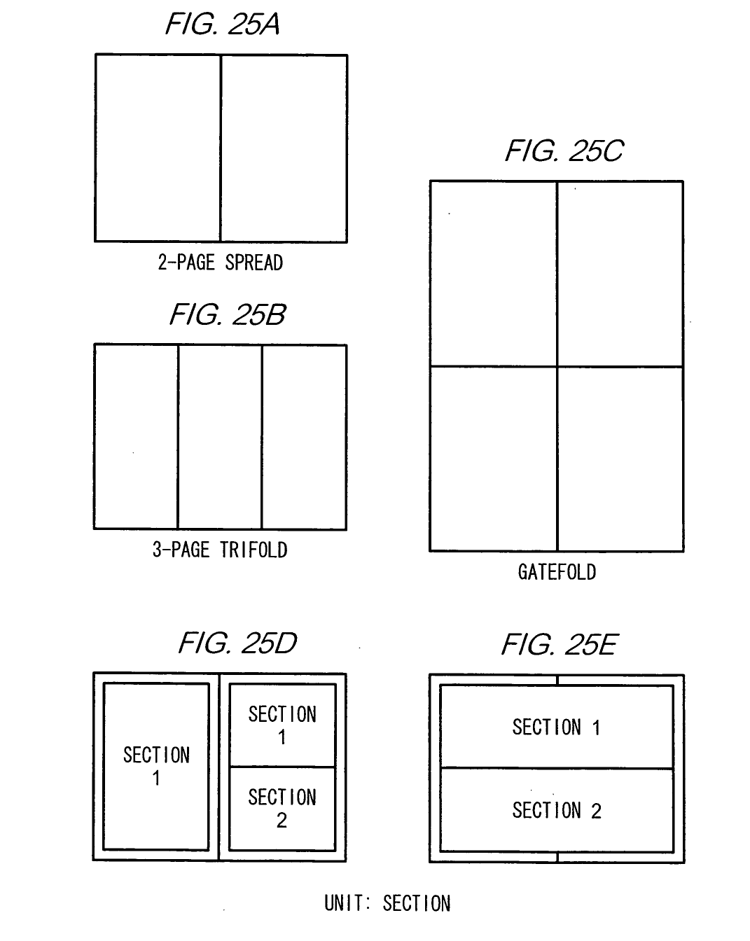

FIG. 25A-25E illustrates a modified example of the layout area. The embodiment described above explains an example, in which the layout area corresponds to a single page, but the layout area is not limited to that. FIG. 25A illustrates a layout area corresponding to two contiguous pages, FIG. 25B a layout area corresponding to three contiguous pages, and FIG. 25C a layout area corresponding to four contiguous pages. In addition, units used for the layout area are not limited to pages. The concept of “Section” is introduced as a layout area unit that cannot be measured in pages. FIG. 25D illustrates an example with one section on a single page and an example with two sections on a single page. FIG. 25E illustrates an example in which the top half and bottom half of a double spread are constituted by different sections. The sections have their own layout information. A document may have a plurality of sections, i.e. a plurality of layout information blocks. The document production apparatus 100 can select one or a plurality of sections from these multiple sections and use them as a layout area. Being able to set layout areas in this manner allows for generating document attribute information in all the respective layout areas. For example, this makes it possible to produce documents having excellent design characteristics suited to 2-page double spreads, 3-page tri-folds, etc.

In addition, in the embodiment described above, explanations were provided regarding examples, in which the document production apparatus 100 is a single device. However, an entire system comprising a plurality of devices may have the functional configuration illustrated in FIG. 1. The system may be a network system produced by communicatively interconnecting a plurality of devices, terminals and equipment. In such a case, so long as the various functional configuration units are communicatively interconnected, they may belong to any of the plurality of devices, etc. In addition, although in the embodiment described above the functional configuration elements are implemented as software modules, the functional elements may be implemented as a hardware configuration of dedicated electronic circuits and the like.

In addition, in the embodiment described above, the CPU 60 assesses compliance with the conditions of application on a rule-by-rule basis for all the rules included in the design expertise information. However, the methods of application of the design expertise information are not limited to that. Neural networks and other learning functionality may be used when applying the design expertise information. Alternatively, the CPU 60 may apply all the rules in sequential order without assessing whether the conditions of application are satisfied. Furthermore, alternatively, the CPU 60 may apply rules randomly selected from among the rules included in the design expertise information without assessing whether the conditions of application are satisfied.

In addition, in the embodiment described above, the CPU 60 acquired layout templates from a template database 11 in accordance with user instructions. However, the methods of layout template acquisition are not limited thereto. For example, the user may input information included in a layout template whenever a document is produced. Alternatively, the document production apparatus 100 may automatically select or generate layout templates in accordance with a predetermined algorithm.

In addition, in the embodiment described above, the CPU 60 first acquired a layout template and then acquired a certain number of objects of a certain type corresponding to the layout template. However, the methods of layout template and object acquisition are not limited thereto. The CPU 60 may first acquire (determine) objects and then acquire a layout template suitable for the number and type of the acquired objects. Alternatively, the CPU 60 may first acquire (determine) objects, then acquire a layout template, and finally select a certain number of objects of a certain type corresponding to the layout template from the initially acquired objects. In addition, the document production apparatus 100 may acquire a complete document (data including object and layout information) without acquiring a template.

In addition, in the embodiment described above, explanations were provided regarding examples, in which document attribute information included five types of attribute information: placement information, overlapping information, blank space information, importance distribution information, and color distribution information. However, the document attribute information does not necessarily have to include these five types of attribute information. In addition, the document attribute information may include attribute information other than these five types of attribute information. The document attribute information is necessary for layout adjustment (correction and editing), as well as for design processing, and may be any information so long as it is generated using layout area units.

In addition, in the embodiment described above, explanations were provided regarding examples, in which unoverlapping processing was carried out based on overlapping information, blank space information, and importance distribution information. However, the CPU 60 may carry out unoverlapping processing using color distribution information as well. Specifically, the CPU 60 may move the objects such that there is no overlapping of color distribution.

In addition, in the embodiment described above, explanations were provided regarding examples, in which blank space information was used when selecting objects helpful in terms of unoverlapping. However, blank space information may be used when determining the direction, in which objects are moved. Alternatively, blank space information may be used when determining the smallest size during the resizing of objects. Furthermore, it may find other uses. As a result, a document can be produced that has a beautiful layout giving a more comprehensive consideration to blank space.

In addition, in the embodiment described above, the processing shown in the flowcharts in FIG. 3, FIG. 7, FIG. 8, and FIGS. 11-17, etc. was implemented as a result of CPU 60 executing control programs stored in the ROM 64. However, the CPU 60 may read programs describing such procedures from storage media storing them into RAM 62 and execute them. Here, the term “storage media” refers to all computer-readable storage media. For example, such storage media may be represented by RAM, ROM, and other semiconductor storage media, floppy disks, hard disks, and other magnetic storage type storage media, CD, CDV, LD, DVD, and other optically readable type storage media, MO, and other magnetic storage type/optically readable type storage media.

### 2. Second Embodiment

2.1. Configuration

Next, explanations are provided regarding a second embodiment of the invention. Below, explanations are provided with emphasis on differences from the first embodiment while omitting features common with the first embodiment and their explanation. In addition, the following explanations use the same reference numerals for elements common with the first embodiment.

FIG. 26 is a block diagram showing the functional configuration of the document production apparatus 100a of the second embodiment. A layout result acquisition module 1 acquires a document. The document is acquired e.g. via a network, a storage medium such as a CD-ROM, or users' manual input via an input device, or is automatically generated by the document production apparatus 100. The document includes at least one object and placement information describing the placement of the object(s) within a layout area. An importance distribution information generation module 2 generates importance distribution information, which shows the distribution of importance of the objects in the layout area based on importance information for each object. A layout content processing module 3 processes the layout of the objects in the document. It should be noted that explanations of the hardware configuration of the document production apparatus 100a are omitted here because it is identical to that of the apparatus illustrated in FIG. 2. Because the CPU 60 executes programs stored in ROM 64, the document production apparatus 100a has the functional configuration illustrated in FIG. 26.

2.1.1. Generation of Importance Distribution Information

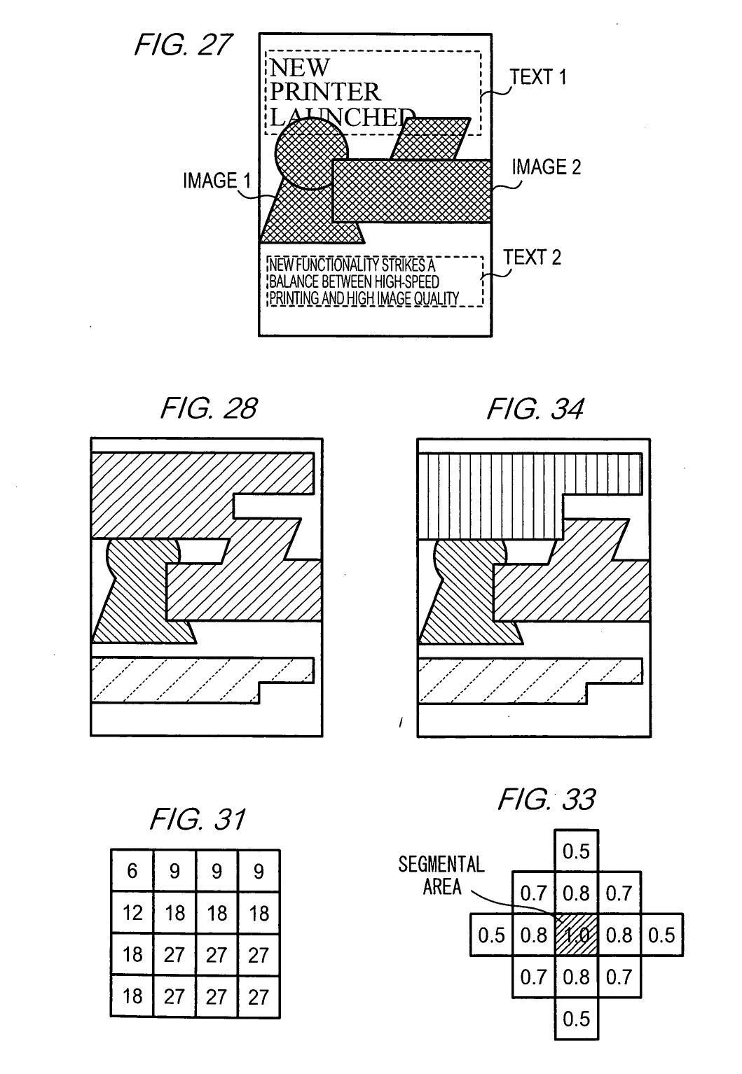

FIG. 27 schematically illustrates the data structure of a document. In the example illustrated in FIG. 27, the document includes four objects: texts 1 and 2, as well as images 1 and 2. Text 1 is placed at the top of the layout area and Text 2 is placed at the bottom of the layout area. Images 1 and 2 are placed horizontally next to each other between texts 1 and 2. Texts 1 and 2 have “text” as their category information, which indicates the category of an object. Images 1 and 2 have “image” as their category information. Layout information corresponding to the objects includes placement information (For example, the x and y coordinates in an XY coordinate system) describing their location in the layout area. The importance information distribution generation module 2 possesses functionality for performing any of the following types of processing described below.

2.1.1.1. Processing 1

In this example, the CPU 60, based on content importance information, calculates the importance of each segmental area. Furthermore, the CPU 60 generates importance distribution information based on the calculated importance.

FIG. 28 provides a visual representation of the importance distribution information. The layout information corresponding to each object includes importance information. In the present embodiment, the importance information is expressed as three levels: “High” (=3), “Middle” (=2), and “Low” (=1). In the following explanations, the “High”, “Middle”, and “Low” degrees of importance are represented as “3”, “2”, and “1”, respectively. In the example illustrated in FIG. 28, the importance information associated with Text 1 and Image 2 is “3”, the importance information associated with Text 2 is “2”, and the importance information associated with Image 1 is “1”.

FIG. 29 is a flowchart showing details of importance distribution information generation processing. First of all, the CPU 60 segments the document into a plurality of segmental areas. Next, the CPU 60 identifies the segmental area in the upper left corner of the layout area as the target segmental area.

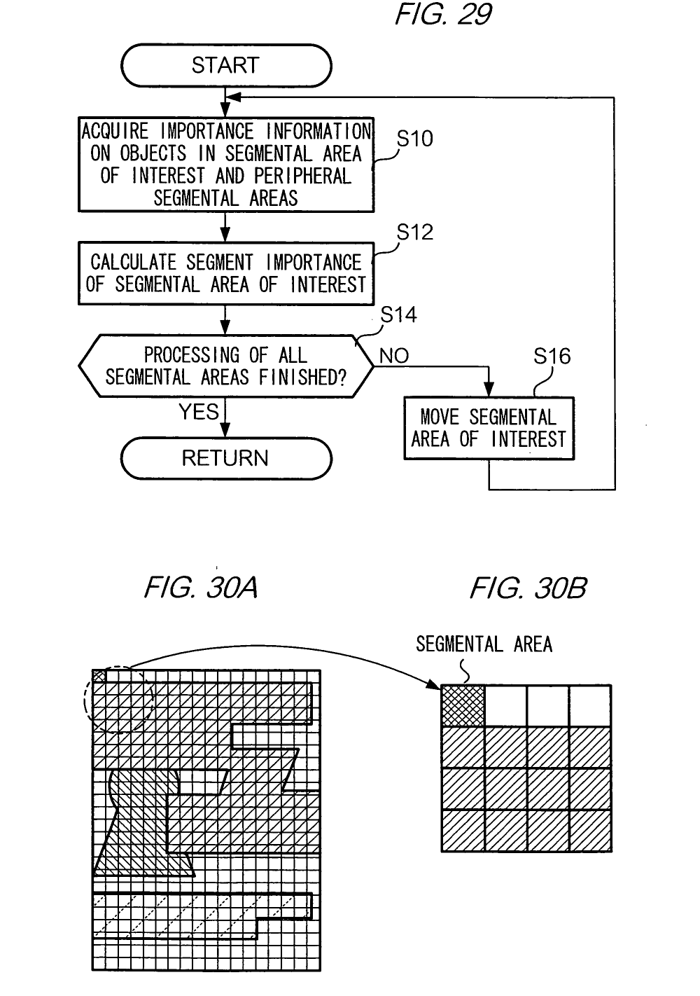

FIG. 30 illustrates an example of a document segmented into segmental areas. The size of the segmental areas is, for example, 10 pixels×10 pixels.

Referring to FIG. 29 again, in Step S10, the CPU 60 acquires content importance information for the target segmental area and peripheral segmental areas. Here, the “peripheral segmental areas” refers to segmental areas that are in a predetermined positional relationship with the target segmental area. Here, the eight segmental areas adjacent to the target segmental area are the peripheral segmental areas. It should be noted that when a target segmental area is located at the edge, the number of the peripheral segmental areas is smaller than 8. In the example illustrated in FIG. 30, Text 1 is placed in the segmental areas in the lower right corner and below the target segmental area. Therefore, the CPU 60 acquires “3” as the content importance information of these peripheral segmental areas. In addition, segmental areas to the right of the target segmental area are a blank space. Therefore, the CPU 60 acquires “0” as the content importance information of these peripheral segmental areas.

In Step S12, based on the acquired content importance information, the CPU 60 calculates the importance Y of the target segmental area from the following equation (1). In equation (1), n shows area numbers (n=1 to 9) used for segmental areas including the segmental area of interest and the peripheral segmental areas. Xₙ indicates content importance in a segmental area with an area number of n.

$$Y = {\sum }_{n} {x}_{n} \qquad ( 1 )$$

For example, in FIG. 30, when the segmental area in the upper left corner of the layout area is the target segmental area, the importance Y of the target segmental area is Y=3+3=6. In this case, no segmental areas exist in the upper left direction, directly above, in the upper left direction, or in the lower left direction from the target segmental area. Therefore, equation (1) is used by assigning “0” to content importance information in these peripheral segmental areas. In addition, when a plurality of objects overlap in a certain segmental area, the total value of their importance is used as the importance of the segmental area. For example, the importance of the segmental areas where Text 2 and Image 1 overlap is 3+3=6.

In Step S14, the CPU 60 determines whether all the segmental areas have been processed. If it is determined that all the segmental area have been processed (“Yes” in Step S14), the CPU 60 terminates the processing shown in FIG. 29. If it is determined that not all the segmental areas have been processed (“No” in Step S14), the CPU 60 updates the target segmental area in Step S16. Specifically, the CPU 60 determines that the segmental area to the right of the current target segmental area is the new target segmental area. The CPU 60 then executes the processing of S10-S14 on the updated target segmental area.

FIG. 31 illustrates importance calculated for a plurality of segmental areas in the vicinity of the upper left corner of the layout area. The importance of each segmental area reflects the importance of its peripheral segmental areas. It should be noted that in the example above, the importance of the target segmental area is calculated from a 3×3 matrix centered on the target segmental area. However, the peripheral segmental areas used in the calculation of the importance of the target segmental area are not limited to those areas.

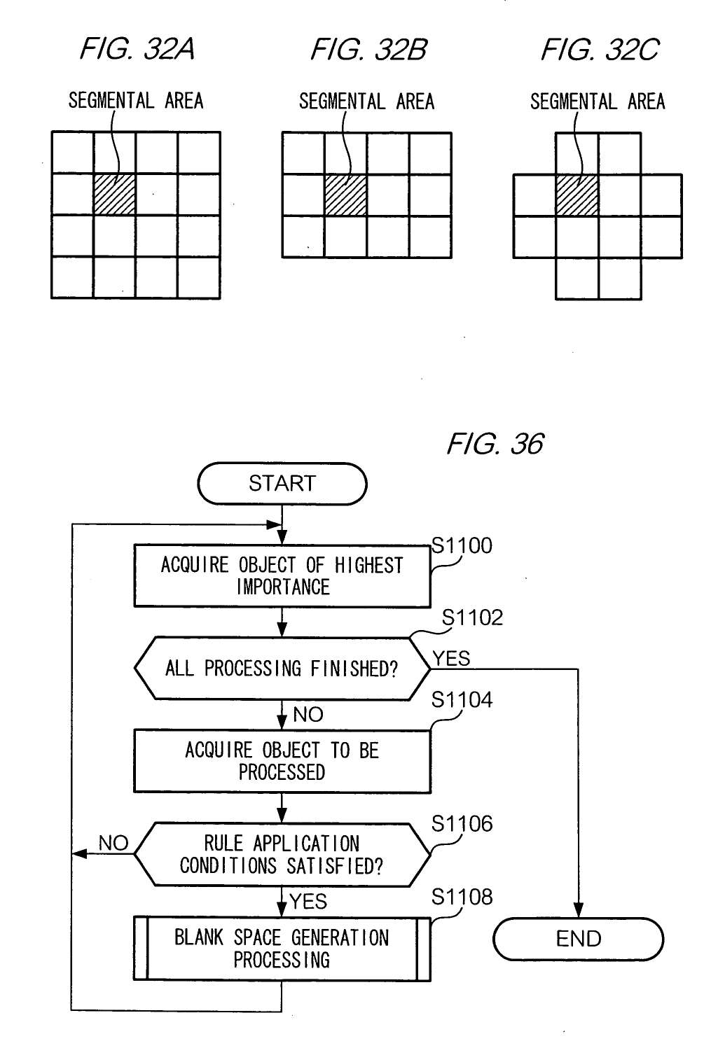

FIGS. 32A-32C illustrate a modified example of the peripheral segmental areas. FIG. 32A illustrates an example, in which a square area consisting of 4×4 segmental areas is used as a computation matrix. FIG. 32B illustrates an example, in which a rectangular area consisting of 4×3 segmental areas is used as a computation matrix. FIG. 32C illustrates an example, in which a near-circular area is used as a computation matrix. It should be noted that although in the examples described above the size of the segmental areas is 10 pixels×10 pixels, the size of the segmental areas is not limited thereto. Areas of an arbitrary size, e.g. such as 20 pixels by 20 pixels, may be used as segmental areas. In addition, the shape of the segmental areas is not limited to square, and rectangular and other shapes may be used as well.

In addition, the equation used to calculate importance Y is not limited to the one shown in equation (1). For example, the content importance of each segmental area may be multiplied by a coefficient. The following equation (2) illustrates an example of a modified equation used for computing importance I. Here, αₙ is a coefficient corresponding to a segmental area with an area number n. The value of αₙ becomes smaller as the distance from the target segmental area increases.

$$I = \sum {α}_{n} {x}_{n} \qquad ( 2 )$$

FIG. 33 provides an example of the coefficients αₙ. In this example, the coefficient α is a value determined by the distance from the target segmental area and lies within the range 0 [symbol] α [symbol] 1. By using such coefficients, the CPU 60 can calculate importance corresponding to the position of the segmental areas.

In the examples described above the importance of the target segmental area was calculated based on the content importance information of objects corresponding to the target segmental area and peripheral segmental areas. However, the CPU 60 may calculate the importance of the target segmental area based on the content importance information of objects corresponding to the segmental area of interest, without taking the peripheral segmental areas into consideration.

2.1.1.2. Processing 2

In this example, the CPU 60 generates importance distribution information based on content importance information and object categories. For example, the CPU 60 multiplies the content importance information by a predetermined coefficient depending on the category of the object. Specifically, the CPU 60 multiplies the content importance information by a coefficient of “1” in case of text and by a coefficient of “2” in case of an image.

In the example illustrated in FIG. 27, the content importance information of Text 1 is “High”, and its post-placement importance is 3×1=3. The post-placement importance refers to importance obtained after placing an object in the layout area. The content importance information of Image 1 is “Low” and, therefore, its post-placement importance is 1×2=2. The content importance information of Image 2 is “High” and, as a result, its post-placement importance is 3×2=6. The content importance information of Text 2 is “Middle”, and, therefore, its post-placement importance is 2×1=2.

FIG. 34 provides a visual representation of importance distribution information calculated as described above. The importance distribution information may include coordinates indicating point within the layout area and the post-placement importance of the points, or information on areas and the post-placement importance of the areas.

2.1.1.3. Processing 3

In this example, the CPU 60 generates content importance information depending on the surface area of objects. First of all, the CPU 60 calculates the surface area of an object. For example, an example is described, in which the surface area of Text 1, Image 1, Image 2 and Text 2 is “100”, “200”, “150”, and “200”, respectively. The CPU 60 calculates post-placement importance based on the following equation (3).

(Post-placement importance)=(content importance information)+(content importance information)×{(target object surface area)−(minimum surface area)}/{(maximum surface area)−(minimum surface area)} . . . (3)

According to equation (3), the post-placement importance of Text 1, Image 1, Image 2, and Text 2 will be “3”, “2”, “4.5”, and “2”.

2.1.1.4. Processing 4

In the above-described processing, post-placement importance was calculated without taking the placement of objects in the layout area into consideration. However, in this example, the CPU 60 generates importance distribution information based on the placement of objects in the layout area. For example, when there is intent to guide the gaze of the viewer from left to right, the eye of the viewer can be guided as intended by raising post-placement importance on the left-hand side of the layout area.

For example, the CPU 60 can generate importance distribution information corresponding to object placement by increasing the coefficient α used in Equation (2) on the left-hand side and reducing it on the right-hand side of the layout area.

2.1.1.5. Processing 5

The above-described processing was an example, wherein each object had corresponding content importance information. However, in this example, the CPU 60 generates importance distribution information that is independent of the content importance information. For example, the CPU 60 generates importance distribution information depending on the categories of the objects. Specifically, the CPU 60 allocates a post-placement importance of “1” to text and a post-placement importance of “2” to images. The post-placement importance allocated to each category is predetermined. Alternatively, the CPU 60, as explained in (d), may determine post-placement importance based on placement in the layout area.

2.1.1.6. Processing 6

In this example, the CPU 60 generates importance distribution information based on the saturation of the objects. Namely, the CPU 60 generates importance distribution information based on color distribution information, in particular, saturation. For example, the CPU 60 normalizes the saturation of color obtained from the color distribution information to a range of “0” to “1.” The CPU 60 multiplies the content importance information of each object by the normalized saturation. As a result of such processing, post-placement importance can be determined in accordance with the color of the objects (e.g. the representative color).

2.1.1.7. Processing 7

In this example, the CPU 60 generates importance distribution information based on object contrast. In the above-described example, the CPU 60 calculated importance distribution information based on the color distribution information. In the same manner, the CPU 60 may calculate importance distribution information based on the contrast included in the color distribution information. For example, when there are objects X and Y and contrasts X1 and Y1, the CPU 60 multiplies the post-placement importance calculated during the above-described processing by weighting coefficients g(X1) and g(Y1) corresponding to the contrasts. Such processing allows for determination of post-placement importance in accordance with object contrast.

2.1.1.8. Other Processing

The importance distribution information may include relationships between the centers of objects and their content importance information. This, For example, clearly identifies the physical distance between objects of high post-placement importance. For example, the CPU 60 can reduce the distance between objects of high post-placement importance. Alternatively, the CPU 60 can increase the distance between objects of high post-placement importance.

In addition, the CPU 60 may calculate post-placement importance using content importance information corresponding to objects, objects placed around the periphery of these objects, and the category, length, size, etc. of the objects.

2.1.2. Layout Content Processing

Next, explanations are provided regarding the functionality of the layout content processing module 3. The layout content processing module 3 performs any of the following functions described below.

2.1.2.1. Blank Space Generation

In this example, the CPU 60 generates blank space between objects based on post-placement importance in order to accentuate the topic. The topic refers to the object one wants to focus on the most in a document. Specifically, it refers to the object with the highest post-placement importance. Accentuating the topic, i.e. making the object with the highest post-placement importance stand out, is an important part of layout processing.

For example, the CPU 60 calculates the distance between objects (the amount of blank space within the layout) for objects whose post-placement importance is higher than a certain threshold value. If the calculated distance is 20 lower than a certain threshold value, the CPU 60 calculates the amount of blank space between the objects based on the following equation (4). In the following equation (4), “I” is post-placement importance. In addition, “a” and “b” are constants.
F(I)=aI+b (4)

The CPU 60 moves or resizes objects such that the difference between the amount of blank space between the objects and the amount of blank space calculated under the equation (4) is kept within a predetermined range. It should be noted that the CPU 60 may allocate blank space in an inverse proportion to the difference in post-placement importance. In addition, in case of a large difference in post-placement importance the CPU 60 may not provide a particularly significant amount of blank space.

2.1.2.2. Resizing

In this example, the CPU 60 resizes objects based on post-placement importance in order to accentuate the topic. For example, the CPU 60 resizes objects such that the ratio of post-placement importance and the ratio of the surface areas of objects X of high post-placement importance and objects Y of low post-placement importance is kept within a predetermined range.

Because as a result of such processing the size ratio between the objects is determined based on post-placement importance, their visibility in the layout area is improved. Therefore, a layout with even higher design characteristics is provided based on the importance distribution information. It should be noted that methods used for determining the surface area ratio are not limited to methods that equalize it with the post-placement importance ratio. For example, the CPU 60 may determine the surface area ratio based on a ratio of powers of post-placement importance. Alternatively, the CPU 60 may determine the surface area ratio based on other functions.

2.1.2.3. Color Processing

In this example, the CPU 60 modifies the color of objects based on post-placement importance. In particular, the CPU 60 modifies their saturation. For example, for objects X and Y with a post-placement importance ratio of k (I_{X}=kI_{Y}; I_{X} and I_{Y} represent the post-placement importance of the objects X and Y), the CPU 60 modifies the saturation of at least one of the objects X and Y such that the saturation ratio of the objects X and Y is increased k times. For example, the CPU 60 modifies the saturation of object X. If the saturation ratio does not reach k or higher when the saturation of object X is modified, the CPU 60 reduces the saturation of object Y. As a result of this processing, objects of higher post-placement importance are modified to have a higher saturation. Therefore, the visibility of the objects of higher post-placement importance can be improved. It should be noted that methods used for determining the saturation ratio are not limited to methods that equalize it with the post-placement importance ratio. For example, the CPU 60 may determine the saturation ratio based on a ratio of powers of post-placement importance. Alternatively, the CPU 60 may determine the saturation ratio based on other functions.

2.1.2.4. Text Font Modification

In this example, the CPU 60 modifies fonts of texts based on post-placement importance. For example, the document production apparatus 100a has a table representing the relationship between the type of the font and post-placement importance stored in advance in an external storage device 70. The CPU 60 modifies the font of the target text based on this table. For example, this table matches fonts of higher visibility to higher post-placement importance.

2.1.2.5. Image Frame Modification

In this example, when working with an image, the CPU 60 uses post-placement importance to add or modify a frame line for the image. For example, the document production apparatus 100a has a table representing the relationship between frame line identifiers and post-placement importance stored in advance in an external storage device 70. The CPU 60 adds or modifies the frame line of the target image based on this table. This table matches frames lines of higher visibility to higher post-placement importance.

2.1.2.6. Processing of Objects with Low Post-Placement Importance

In this example, the CPU 60 makes objects of low post-placement importance relatively less conspicuous.

2.1.2.6.1. Removal of Objects

In this example, the CPU 60 removes objects satisfying certain conditions from the layout area. For example, if the post-placement importance of the target object is lower than a threshold value TH5 and the total number of objects is lower than a threshold value TH6, the CPU 60 removes the target object from the layout area. Because the object of low post-placement importance is removed, the visibility of objects of relatively higher post-placement importance can be improved.

2.1.2.6.2. Blending Objects with Background

In this example, the CPU 60 blends objects that satisfy certain conditions with the background. For example, if the post-placement importance of a target object is lower than a certain threshold value and the total number of objects is lower than a certain threshold value, the CPU 60 blends the target object with the background. Because the object of low post-placement importance is merged with the background, the visibility of objects of relatively higher post-placement importance can be improved. Such blending is carried out, For example, by increasing the transparency of the image. Alternatively, the blending may be performed by applying a mask of a certain prescribed color (For example, light blue, etc.) to the image. Furthermore, the blending may be carried out through a blurring process using a blurring filter. Furthermore, alternatively, the blending may be carried out by bringing the color of the image closer to gray.

2.1.2.6.3. Text Length Reduction

In this example, the CPU 60 reduces the length of text with a post-placement importance lower than a certain threshold value. Reducing the space occupied by text of low post-placement importance allows for increasing blank space around the periphery of objects of high post-placement importance. This makes it possible to improve the visibility of objects of high post-placement importance.

2.1.2.6.4. Image Resolution Reduction

In this example, the CPU 60 changes the resolution of images with a post-placement importance lower than a certain threshold value to a lower resolution. Reducing the resolution of the images permits reduction in the data size of the document.

2.2. Operation

Next, explanations are provided regarding the operation of the document production apparatus 100a. Here, the explanations focus on differences from the first embodiment.

In Step S208, the CPU 60 performs at least one kind of processing included in the above-described importance distribution information generation processing. The thus produced importance distribution information includes the post-placement importance of the objects and placement information regarding the objects.

Next, explanations are provided regarding the design processing of Step S118.

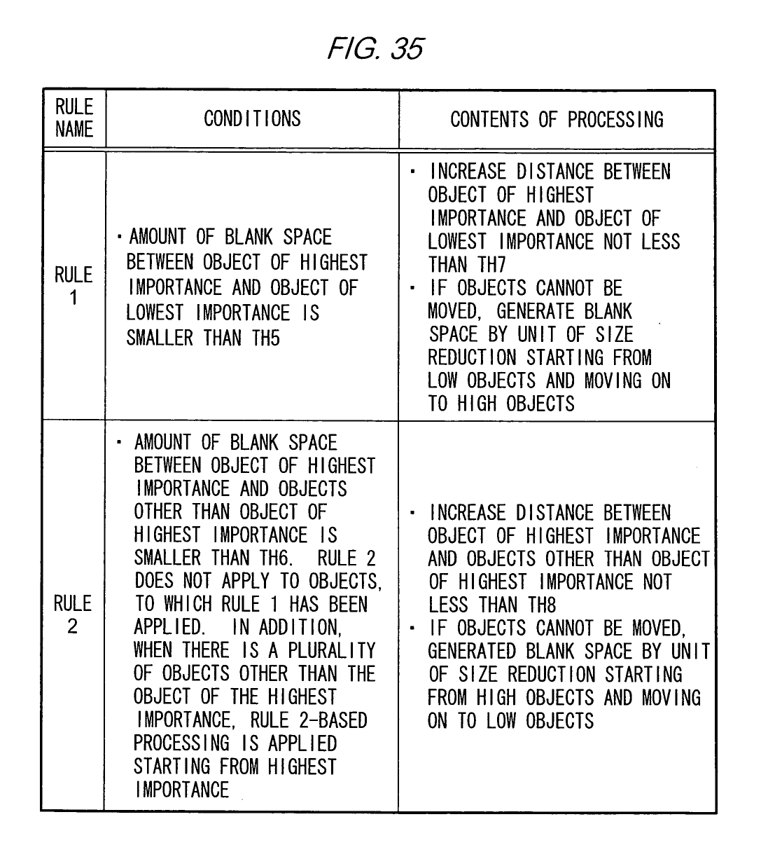

FIG. 35 illustrates an example of design expertise information. In this embodiment, the design expertise information includes the two rules illustrated in FIG. 35. These rules include conditions of application and design processing. Using the rules, the CPU 60 determines whether the document satisfies the conditions of application. If it is determined that the conditions of application are satisfied, the CPU 60 applies the corresponding design processing.

In FIG. 35, the threshold values TH5 and TH6 are threshold values used for the amount of blank space between objects. The threshold values TH7 and TH8 are threshold values used for the distance between two objects. In this example, TH5, TH6, TH7 and TH8 satisfy the conditions: TH5>TH6 and TH7>TH8.

The condition of application of Rule 1 is that the amount of blank space between the objects of the highest post-placement importance and the objects of the lowest post-placement importance should be smaller than the threshold value TH5. The corresponding design processing consists in processing that increases the distance between the objects of the highest post-placement importance and the objects of the lowest post-placement importance to not less than the threshold value TH7. Furthermore, if the corresponding design processing is unable to move these objects, or if they can be moved but the distance cannot be increased to not less than the threshold value TH7, the design processing includes object size reduction processing. Such size reduction is carried out in the order from the objects of the lowest post-placement importance to the objects of the highest post-placement importance.

The condition of application of Rule 2 is that the amount of blank space between the objects of the highest post-placement importance and other objects should be smaller than the threshold value TH6. Furthermore, the condition of application includes the condition that Rule 1 has not been applied. The corresponding design processing consists in processing that increases the distance between the objects of the highest post-placement importance and other objects to not less than the threshold value TH8. Furthermore, if the corresponding design processing is unable to move these objects, or if they can be moved but the distance cannot be increased to not less than the threshold value TH8, the design processing includes object size reduction processing. Such size reduction is carried out in the order from other objects to the objects of the highest post-placement importance. When there is a plurality of other objects, the design processing is applied starting from objects of higher post-placement importance.

FIG. 36 is a flowchart showing details of design processing. In Step S1100, the CPU 60 identifies the objects of the highest importance among unprocessed objects in the document. In Step S1102, the CPU 60 determines whether all objects have been processed. If it is determined that all the objects have been processed (“Yes” in Step S1102), the CPU 60 terminates the processing shown in FIG. 36. If it is determined that not all the objects have been processed (“No” in Step S1102), the CPU 60 transfers processing to Step S1104.

In Step S1104, the CPU 60 identifies the target object subject to processing. In Step S1106, the CPU 60 determines whether the target object satisfies the conditions of application of the rules. If it is determined that the conditions of application are satisfied (“Yes” in Step S1106), then, in step S1108, the CPU 60 performs blank space generation processing that generates blank space. If it is determined that the conditions of application are not satisfied (“No” in Step S1106), the CPU 60 transfers processing to Step 1100 again.

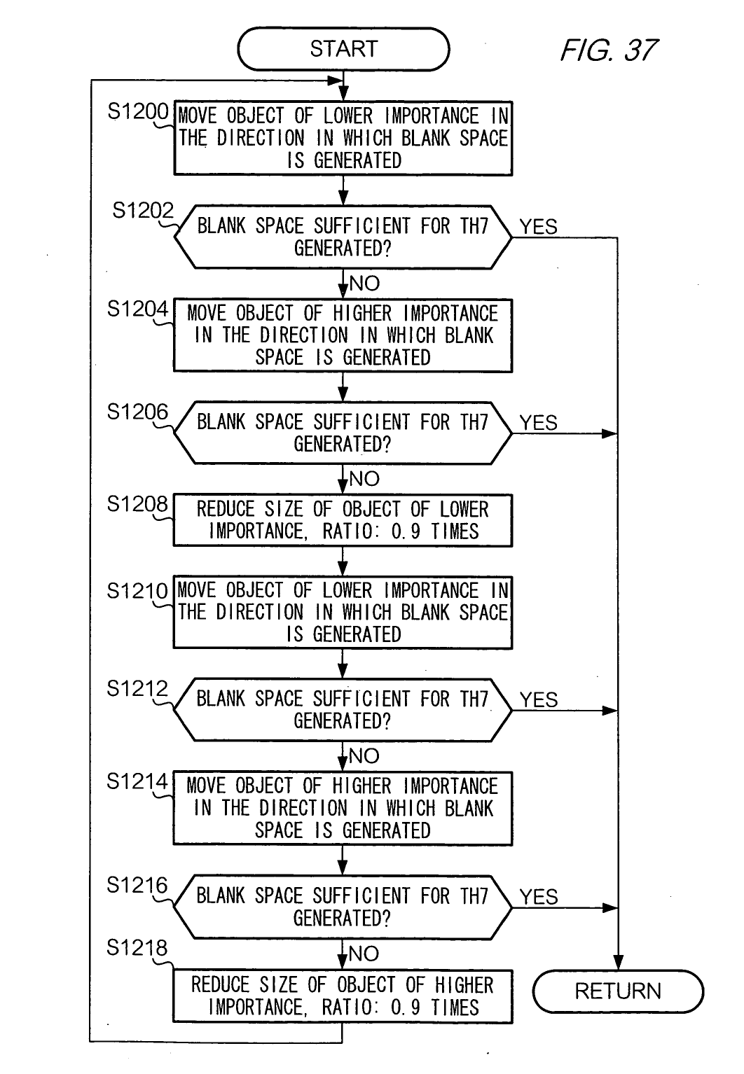

FIG. 37 is a flowchart outlining blank space generation processing corresponding to Rule 1. In Step S1200, the CPU 60 moves the object of lower post-placement importance in the direction, in which blank space is generated, i.e. in the direction away from the object of higher post-placement importance. In Step S1202, the CPU 60 determines whether a blank space equal to or exceeding TH7 has been generated between the two objects. If it is determined that a blank space equal to or exceeding TH7 has been generated (“Yes” in Step S1202), the CPU 60 terminates the processing of FIG. 37. If it is determined that no blank space equal to or exceeding TH7 has been generated (“No” in Step S1202), the CPU 60 transfers processing to Step S1204.

In Step S1204, the CPU 60 moves the object of higher post-placement importance in the direction, in which blank space is generated. In Step S1206, the CPU 60 determines whether a blank space equal to or exceeding TH7 has been generated between the two objects. If it is determined that a blank space equal to or exceeding TH7 has been generated (“Yes” in Step S1206), the CPU 60 terminates the processing of FIG. 37. If it is determined that no blank space equal to or exceeding TH7 has been generated (“No” in Step S1206), the CPU 60 transfers processing to Step S1208.

In Step S1208, the CPU 60 reduces the size of the object of lower post-placement importance by a predetermined ratio, e.g. 0.9 times. In Step S1210, the CPU 60 moves the object of lower post-placement importance in the direction, in which blank space is generated. In Step S1212, the CPU 60 determines whether a blank space equal to or exceeding TH7 has been generated between the two objects. If it is determined that a blank space equal to or exceeding TH7 has been generated (“Yes” in Step S1212), the CPU 60 terminates the processing of FIG. 37. If it is determined that no blank space equal to or exceeding TH7 has been generated (“No” in Step S1212), the CPU 60 transfers processing to Step S1214.

In Step S1214, the CPU 60 moves the object of higher post-placement importance in the direction, in which blank space is generated. In Step S1216, the CPU 60 determines whether a blank space equal to or exceeding TH7 has been generated between the two objects. If it is determined that a blank space equal to or exceeding TH7 has been generated (“Yes” in Step S1216), the CPU 60 terminates the processing of FIG. 37. If it is determined that no blank space equal to or exceeding TH7 has been generated (“No” in Step S1216), the CPU 60 transfers processing to Step S1218.

In Step S1218, the CPU 60 reduces the size of the object of higher post-placement importance by a predetermined ratio, e.g. 0.9 times. The CPU 60 then again transfers processing to Step S1200.

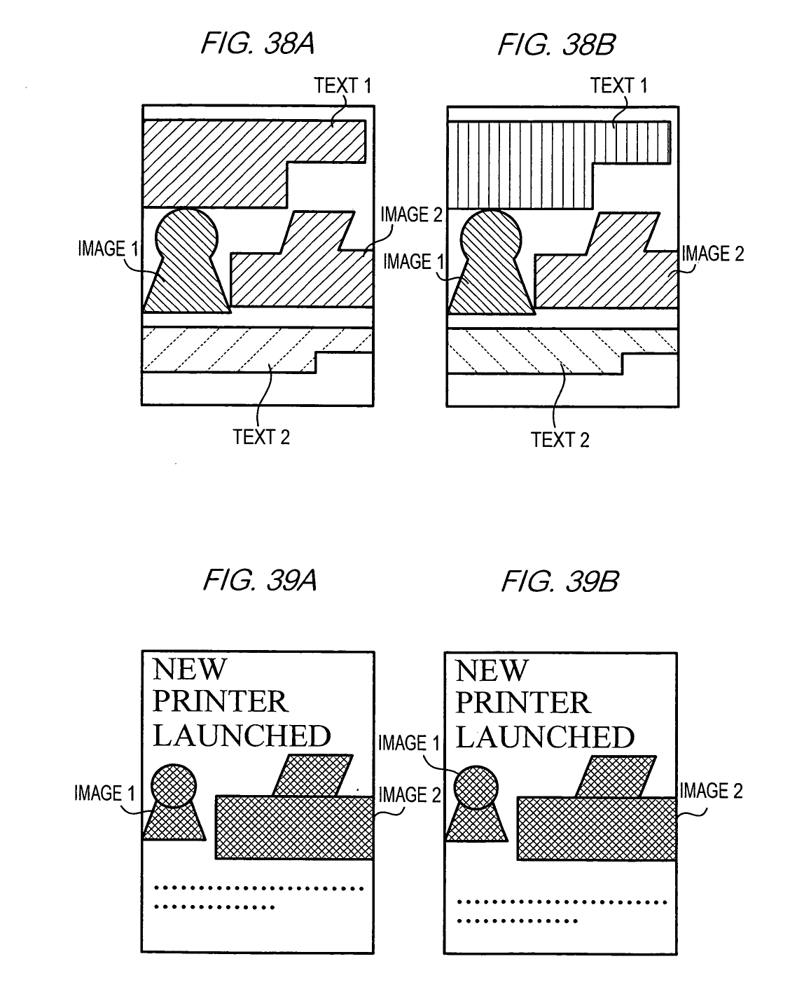

FIG. 38A provides a visual representation of the importance distribution information generated in the present embodiment. FIG. 38B illustrates a comparative example. In the Comparative Example, the importance distribution information is generated based on content importance information alone. In the example of FIG. 38, the content importance information of Text 1, Text 2, Image 1 and Image 2 is “High”, “Middle”, “Low”, and “High”. In the Comparative Example, the post-placement importance of Text 1 and Image 2 is the highest, the post-placement importance of Text 2 is next in magnitude, and the post-placement importance of Image 1 is the lowest.

By contrast, in the present embodiment, importance distribution information is generated using two or more kinds of information selected from content importance information, placement information, and color distribution information. In the example of FIG. 38A, the post-placement importance of Image 2 is the highest, the post-placement importance of Text 1 is next in magnitude, and the post-placement importance of Image 1 and Text 2 is the lowest.

FIGS. 39A and 39B illustrate examples obtained by subjecting the examples of FIGS. 38A and 38B to the design processing of the present embodiment. This design processing is explained in detail below.

(1) In the Comparative Example

(a) Application of Rule 1

1. The CPU 60 identifies the object with the highest post-placement importance. Image 2 and Text 1 are identified in this case. First of all, the CPU 60 applies the following processing to Image 2.

2. The CPU 60 obtains the amount of blank space to the object with the lowest post-placement importance. After that, it obtains the amount of blank space to Image 1. Image 1 and Image 2 are arranged in a row. In this case, the amount of blank space is an amount of blank space in the horizontal direction of Image 1 and Image 2. Because Image 1 and Image 2 are touching each other, the amount of blank space is “0”.

3. Because the amount of blank space is smaller than TH5, the CPU 60 performs the following blank space generation processing.

4-1. The CPU 60 determines whether the object of lower post-placement importance can be moved in the direction, in which blank space is generated. In this case, the object of lower post-placement importance is Image 1. The direction, in which blank space is generated is to the left. However, no movement is carried out because there is no blank space to the left of Image 1.

4-2. The CPU 60 determines whether the object of higher post-placement importance can be moved in the direction, in which blank space is generated. The object of higher post-placement importance is Image 2. The direction, in which blank space is generated, is to the right. However, no movement is carried out because there is no blank space to the right of Image 2.

4-3. The CPU 60 reduces the size of Image 1. Furthermore, the CPU 60 moves the reduced Image 1 to the left. This makes it possible to generate an amount of blank space not less than TH7.

Next, the CPU 60 performs processing on text 1 as the target object. Determination of the distance to Image 1, which has the lowest post-placement importance, shows that the amount of blank space is lower than the threshold value TH5. Therefore, the CPU 60 performs blank space generation processing. However, in this case, blank space can be generated if Image 1 is moved downwardly. Therefore, the CPU 60 moves Image 1 downwards.

(b) Application of Rule 2

1. The CPU 60 identifies the object with the highest post-placement importance. Image 2 and Text 1 are identified in this case, in the same manner as in Rule 1. Due to the application of Rule 1, the amount of blank space between Text 1 and other objects is larger than TH6. For this reason, no design processing is performed here. In addition, because the amount of blank space between Image 2 and Text 2 is exactly TH6, no design processing is performed either.

As a result, a document is obtained that looks like the one in FIG. 39A.

(2) In the Present Embodiment

(a) Application of Rule 1

1. The CPU 60 identifies the object with the highest post-placement importance. Thus, Image 2 is identified.

2. The CPU 60 obtains the amount of blank space to the object with the lowest post-placement importance. Thus, the amounts of blank space to Image 1 and Text 2 are obtained.

3. Blank space generation processing is performed because all blank space amounts described in paragraph 2 above are smaller than TH1. The blank space generation processing performed between Images 1 and 2 has the same content as described above. In addition, the blank space generation processing between Image 2 and Text 2 terminates after moving Text 2 downwards because Text 2 can move downwardly.

(b) Application of Rule 2

1. The CPU 60 identifies the object with the highest post-placement importance. In this case, Image 2 is identified.

2. The CPU 60 calculates the amount of blank space to other objects. In this case, there are three other objects: Text 1, Image 1, and Text 2. The CPU 60 performs processing on these objects by starting from Text 1, which has the highest post-placement importance.

3. The amount of blank space between Text 1 and Image 1 is smaller than the threshold value TH6. Therefore, the CPU 60 generates blank space by moving Text 1 upwards.

4. Besides Text 1, Image 1 and Text 2 have been already processed using Rule 1, and Rule 2 is not applied to them.

As a result, a document is obtained such as the one shown in FIG. 39B. In comparison with the layout results of FIG. 39A, in FIG. 39B, the important Image 2 has a larger amount of blank space around its periphery. In comparison with FIG. 39A, FIG. 39B has a better design in terms of balanced placement of the important image.

In this manner, in the present embodiment, the layout of the document is adjusted based on document attribute information concerning objects laid out in the layout area. In addition, the document undergoes design processing based on design expertise information.

What is claimed is:

1. A document production system, comprising:
a document acquisition unit that acquires a document including data including at least one object placed in a layout area and layout information identifying the placement of the at least one object in the layout area;
an attribute information generation unit that generates attribute information describing the attributes of the document based on at least either one of the object(s) and layout information included in the document acquired by the document acquisition unit; and
a layout processing unit that processes at least either one of the layout information or an object among the at least one object based on the attribute information generated by the attribute information generation unit.

2. The document production system according to claim 1,
wherein the layout information includes importance information describing the importance of each object among the at least one object,
the attribute information generation unit generates attribute information including importance distribution information describing the distribution of importance in the layout area, and
the layout processing unit processes at least either one of the layout information or an object among the at least one object based on the importance distribution information.

3. The document production system according to claim 2, further comprising segment importance information generation unit that generates, for each segmental area obtained by segmenting the layout area into a plurality of areas, segment importance information describing the importance of the segmental area based on importance information concerning objects corresponding to the segmental area or importance information concerning at least one object corresponding to another segmental area disposed in a specified positional relationship relative to the segmental area,
wherein the attribute information generation unit generates importance distribution information based on the segment importance information generated by the segment importance information generation unit.

4. The document production system according to claim 1,
wherein the document further comprises information describing an output unit of the document, and
the layout area is different from the output units.

5. The document production system according to claim 1,
wherein the layout information includes category information describing the categories of each one of the plurality of objects, and
the attribute information generation unit generates attribute information based on the category information.

6. The document production system according to claim 1,
wherein the layout information includes size information describing the size of each one of the plurality of objects, and
the attribute information generation unit generates attribute information based on the size information.

7. The document production system according to claim 1,
wherein the attribute information generation unit generates attribute information including shape information describing the shape of each one of the at least one object.

8. The document production system according to claim 1,
wherein the attribute information generation unit generates attribute information including overlapping information describing the overlapping of objects.

9. The document production system according to claim 1,
wherein the attribute information generation unit generates attribute information including blank space information describing blank space, i.e. an area other than the areas occupied by the at least one object in the layout area.

10. The document production system according to claim 1, wherein the attribute information generation unit generates attribute information including importance distribution information describing the distribution of color within the layout area.

11. The document production system according to claim 1, further comprising:
a content storage unit that stores a plurality of objects;
a layout storage unit that stores a plurality of layout information items;
a selection unit that selects a layout information item from the plurality of layout information items stored in the layout storage unit and at least one of the plurality of objects stored in the content storage unit; and
an initial layout unit that places the at least one object selected by the selection unit in the layout area in accordance with the layout information selected by the selection unit and generating a document,
wherein the document acquisition unit acquires the document generated by the initial layout unit.

12. The document production system according to claim 1, further comprising design expertise information storage unit that stores design expertise information including rules for processing at least either one of the layout information or an object among the at least one object
wherein the layout processing unit processes at least either one of the layout information or an object among the at least one object based on the design expertise information stored in the design expertise information storage unit.

13. A document production method, comprising:
acquiring a document including data including at least one object placed in a layout area and layout information identifying the placement of the at least one object in the layout area;
generating attribute information for the acquired document based on at least either one of the object(s) and layout information included in the acquired document; and
processing at least either one of the layout information or an object among the at least one object based on the attribute information.

14. A program causing a computer to execute:
acquiring a document including data including at least one object placed in a layout area and layout information identifying the placement of the at least one object in the layout area;
generating attribute information for the acquired document based on at least either one of the object(s) and layout information included in the acquired document; and
processing at least either one of the layout information or an object among the at least one object based on the attribute information.

15. A storage medium for storing a program that causing a computer to execute:
acquiring a document including data including at least one object placed in a layout area and layout information identifying the placement of the at least one object in the layout area;
generating attribute information for the acquired document based on at least either one of the object(s) and layout information included in the acquired document; and
processing at least either one of the layout information or an object among the at least one object based on the attribute information.
